(19) United States
(12) Patent Application Publication
(10) Pub. No.: US 2014/0164228 A1
(43) Pub. Date: Jun. 12, 2014

(54) METHODS AND SYSTEMS FOR VALUE TRANSFERS USING A READER DEVICE

(71) Applicant: Manish Pathak, Los Gatos, CA (US)

(72) Inventor: Manish Pathak, Los Gatos, CA (US)

(21) Appl. No.: 14/101,725

(22) Filed: Dec. 10, 2013

Related U.S. Application Data
(60) Provisional application No. 61/735,956, filed on Dec. 11, 2012.

(51) Int. Cl. G06Q 20/32

(52) U.S. Cl. CPC G06Q 20/3223
USPC 705/39

(57) ABSTRACT

Embodiments of the invention are directed to a method and system for conducting fund transfers between a plurality of payment devices using a reader device associated with a mobile device. The plurality of payment devices may be read by the reader device and payment data for the plurality of payment devices may be sent to a payment processing network to perform a funds transfer process. In other embodiments, a plurality of prepaid cards can be read by the reader device and prepaid card data for the plurality of prepaid cards may be sent to the payment processing network to perform a consolidation of the values of the plurality of prepaid cards.

### CROSS-REFERENCES TO RELATED APPLICATIONS

This application is a non-provisional application of and claims the benefit of priority of U.S. Provisional Application No. 61/735,956, tiled, “RELOADING PAYMENT DEVICES USING A PORTABLE READER, filed on Dec. 11, 2012, which is herein incorporated by reference in its entirety for all purposes.

### BACKGROUND

Consumers are increasingly conducting transactions using mobile devices (e.g., smart phones and other portable devices). In addition, financial transactions are increasingly being conducted using payment devices (e.g., credit cards, debit cards, prepaid cards, stored value cards, etc.) rather than with (e.g., banknotes) with set monetary values.

With physical forms of tender (e.g. bank notes), one consumer can easily hand over funds to another consumer in order to transfer funds. However, some consumers may forgo carrying any physical forms of tender and may conduct all of their transactions using payment devices. As consumers shift towards conducting transactions with payment devices, it makes it difficult to transfer funds between individuals. For example, if one person pays for a meal for a large party and needs to be reimbursed by the other members of the party, issues may arise if some members of the party do not carry cash and only have credit cards or debit cards.

One current solution is that the payor can go to their financial institution (e.g., bank) and transfer funds from the payor's bank account to the payee's bank account. Another solution is that the payor can go to automated teller machine (ATM) and obtain cash, or get a money order or cashier's check, to give to the person owed the funds.

One limitation of the current options is that it may require the person receiving the funds to go to their bank or go through the process of depositing the funds into their account. Another problem with the cash solution is that the payee may not want cash and may want the funds directly in their account (e.g., to directly reimburse the account used to pay for the meal). There may also not be a bank conveniently located to their current location. In addition, a bank transfer between accounts may have some limitations as it typically would require the payee to provide financial details (e.g., a bank account number and routing number) to the payor.

Thus, new and enhanced methods of providing for the transfer of funds between individuals that addresses the above problems have become necessary to provide greater and efficient user services while preserving and utilizing existing systems and messaging capabilities.

Embodiments of the invention address the above problems, and other problems, individually and collectively.

### BRIEF SUMMARY

Embodiments of the present invention are related to systems and methods for a process of transferring funds from a first payment device associated with a first user to a second payment device associated with a second user using a reader device associated with a mobile device. Embodiments are further related to a process for consolidating funds contained in one or more prepaid cards into an account using a reader device associated with a mobile device.

One embodiment of the invention is directed to a method comprising receiving, by a reader device, a first account identifier from a first payment device when the first payment device is passed through the reader device. The method further comprises receiving, by the reader device, a second account identifier from a second payment device when the second payment device is passed through the reader device. The reader device then generates a data message that includes the first account identifier and the second account identifier. The method further comprises sending the data message to a mobile device associated with the reader device, where the data message is for transferring funds between a first account associated with the first account identifier and a second account associated with the second account identifier.

Another embodiment of the invention is directed to a method comprising receiving, from a mobile device, a message including a first account identifier and a second account identifier. The first account identifier and the second account identifier were previously received by the mobile device via a reader device associated with the mobile device. The message may further include a funding amount. The method may further comprise evaluating the message, by a computer, to determine a first issuer associated with the first account identifier and a second issuer associated with the second account identifier. The method further comprises initiating a transfer of funds for the funding amount from a first account at the first issuer to a second account at the second issuer.

Another embodiment of the invention is directed to a server computer comprising a processor and a computer readable medium coupled to the processor, the computer readable medium comprising code, executable by the processor for implementing a method. The method comprises receiving, from a mobile device, a message including a first account identifier and a second account identifier. The first account identifier and the second account identifier were previously received by the mobile device via a reader device associated with the mobile device. The message may further include a funding amount. The method may further comprise evaluating the message, by a computer, to determine a first issuer associated with the first account identifier and a second issuer associated with the second account identifier. The method further comprises initiating a transfer of funds for the funding amount from a first account at the first issuer to a second account at the second issuer.

These and other embodiments of the invention are described in further detail below with reference to the Figures and the Detailed Description.

### BRIEF DESCRIPTION OF THE DRAWINGS

FIG. 1 shows a system diagram of a system according to an embodiment of the claimed invention.

FIG. 2 shows a block diagram of a mobile device according to an embodiment of the claimed invention.

FIGS. 3A & 3B show a diagram of a reader device and a mobile device according to an embodiment of the claimed invention.

FIG. 4 is a flowchart describing the process of registering a reader device for enrollment in a value transfer system according to an embodiment of the invention.

FIGS. 5A & 5B show a depiction of the process of registering a reader device for enrollment in a value transfer system according to an embodiment of the claimed invention.

FIG. 6 is a flowchart describing the process of adding an account for use in a value transfer system according to an embodiment of the invention.

FIGS. 7A-7C show a depiction of the process of adding an account for use in a value transfer system according to an embodiment of the invention.

FIG. 8 is a flowchart describing the process of sending funds using a value transfer system according to an embodiment of the invention.

FIGS. 9A-9C show a depiction of the process of sending funds using a value transfer system according to an embodiment of the invention.

FIGS. 10A & 10B are flowcharts describing the process of transferring funds using a value transfer system according to an embodiment of the invention.

FIGS. 11A-11C show a depiction of the process of receiving funds using a value transfer system according to an embodiment of the invention.

FIGS. 12 & 13 are flowcharts describing the process of consolidating prepaid cards using a value transfer system according to an embodiment of the invention.

FIGS. 14A-14G show a depiction of the process of consolidating prepaid cards using a value transfer system according to an embodiment of the invention.

FIG. 15 shows a block diagram of a computer apparatus according to an embodiment of the invention.

### DETAILED DESCRIPTION

Prior to discussing embodiments of the invention, descriptions of some terms may be helpful in understanding embodiments of the invention.

The term “reader device” may refer to a device that can be configured to read and obtain data from a payment device. In some embodiments, the reader device may be a portable reader device that is configured to connect with a mobile device, or other computing device. In such embodiments, the reader device may be physically connected to the mobile device, or may be connected to the mobile device via a wireless connection (e.g., Bluetooth™). The portable reader device may be connected to the mobile device when the portable reader device is needed to read a payment device, and otherwise physically disconnected from the mobile device when not required. In other embodiments, the reader device may be embedded within a mobile device, or other computing device, such that the reader device and the mobile device are a single device. In such embodiments, the reader device may be activated by the mobile device when needed (e.g., by accessing the reader device via an application stored on the mobile device, via a switch or button).

The reader device may be configured to read and obtain data from payment devices when payment devices are placed within proximity to the reader device. In some embodiments, the reader device may be configured to read and obtain data from a magnetic stripe portion embedded on a payment device. The magnetic stripe portion may contain financial data for an account associated with the payment device. In some embodiments, the reader device may be configured to read and obtain data from payment devices when the payment devices come into physical contact with the reader device (e.g., the magnetic stripe of the payment device is swiped through a portion of the reader device or a contactless element of the payment device is passed within proximity to the reader device).

The term “payment device” may refer to a device that is used to conduct a transaction. The payment device may be a debit device (e.g., a debit card), credit device (e.g., a credit card), or stored value devices (e.g., a prepaid or stored value card with a value that may only be used at a specific merchant or collection of merchants). In some embodiments, a magnetic stripe portion may be embedded on the payment device, containing data associated with financial accounts. In some embodiments, an account number may be imprinted on the body of the payment device.

In some embodiments, a payment device may be alternatively referred to as a “prepaid card” or the like. A prepaid card may be a closed loop card that can only be used at a single merchant or a specific group of merchants. Prepaid cards may also be used with transportation systems (e.g. transit cards), or issued by a financial institution (e.g., Visa, MasterCard, American Express, Discover).

The term “mobile device” may refer to user device that is used to conduct a transaction, including a transfer of funds. The mobile device may be capable of conducting communications over a network. A mobile device may be in any suitable form. For example, suitable mobile devices can be hand-held and compact so that it can fit into a user's wallet and/or pocket (e.g., pocket-sized). The mobile device can include a processor, and memory, input devices, and output devices, operatively coupled to the processor. Specific examples of mobile devices include cellular or mobile phones, tablet computers personal digital assistants (PDAs), pagers, portable computers, smart cards, and the like.

The term “passed through” may refer to an interaction between two or more devices or objects. For example, for an interaction between a payment device and a reader device, passed through may refer to a physical interaction between the payment device and the reader device whereby the payment device is at least partially inserted into the reader device (e.g., a swipe through a swiping portion of the reader device or a mobile device with an embedded reader device). Passed through may also refer to a contactless element of the payment device moving within proximity of the reader device such that the reader device can access data stored on the contactless element.

The term “message” may refer to any data or information that may be transported from one entity to another (e.g., one computing device to another computing device). Further, a message may include a single signal or data packet or a combination of multiple transporting signals. For example, a message may include an analog electrical signal or digital signal that constitutes binary information that may be interpreted as communicating information. Additionally, a message may comprise any number of pieces of information including both private and/or public information. Messages may be communicated internally between devices within a secure organization or externally between a device within a secure organization or network to a device outside of a secure organization, area, or communication network. Additionally, whether information contained within a message is considered public or private may be dependent on who the secure organization or area originating the message is, who the message is being sent to (e.g., recipient computer or requesting computer), or in any other suitable manner. Additionally, messages may be modified, altered, or otherwise changed to comprise encrypted or anonymized information.

The term “account identifier” may refer to any information that may be used to identify an account. The account identifier may include a series of alphanumeric characters, one or more graphics, a token, a bar code, a QR code, or any other information that may be associated with an account. For example, the account identifier may be an account number associated with a financial account, or may be a special identifier generated randomly or according to a predetermined algorithm, code, or shared secret. The account identifier for a financial account may be generated by an issuer associated with the financial account, and distributed to the payment processing network. The account identifier may also be embedded in a payment device, such as in a magnetic stripe portion of a payment device in the form of a payment card. In other embodiments, the account identifier may be stored in a memory component of a mobile device or a reader device for identifying the financial account associated with the account identifier.

The term “token” may refer to information that is derived from actual data and used to protect the actual data. Using a token in place of sensitive data may serve as an additional security layer to a personal account number (“PAN”) or other account identifiers and in effect may become a substitute to the PAN or account identifier. In some embodiments, a token may be generated based on actual data (e.g., transaction data, account data, security credentials). The token may be used in place of the actual data to protect the actual data from being intercepted or compromised.

The term “AFT request message” may refer to an account funding transaction request message that may be a message sent as part of request to debit funds from an account. An Account Funding Transaction (AFT) is a transaction for supplying funds to another account such as a credit, prepaid, debit, ATM or on-line account. An AFT request message may be sent by the payment processing network to an issuer to request that funds be debited from a sending account. In some embodiments, the AFT request message carries only the account number or account identifier associated with the payment device of a sender, and may not carry any financial information about the recipient of the transfer of funds.

The term “AFT response message” may refer to an account funding transaction response message that may be a message sent in response to a request to debit funds from an account at an issuer computer. The AFT response message may be sent to the payment processing network from an issuer computer indicating whether a debit request for a sending account at the issuer computer has been approved or declined.

The term “OCT request message” may refer to an Original Credit Transaction (OCT) request message which may be a message sent as part of request to credit funds to an account. An OCT is typically a clearing and settlement credit transaction designed for use in business applications such as a business money transfer or business-to-consumer repayments. When used in the context of the present invention for transferring funds, the OCT is the transaction used to deliver funds to the recipient account. Typically, the OCT transaction is separate from, and takes place after, the AFT transaction. This timing is to ensure that payment funds are secured before funds are sent to the recipient. In some embodiments, the OCT request message carries only the account number or account identifier associated with the payment device of a recipient, and may not carry any financial information about the sender associated with the transfer of funds. In some embodiments, the OCT request process may be conducted at the end of the business day in batches. In other embodiments, the OCT request process may be conducted in real-time.

The term “OCT response message” may refer to an original credit transaction (OCT) response message that may be a message sent in response to a request to credit funds to an account at an issuer computer. The OCT response message may be sent to the payment processing network from an issuer computer indicating whether a funding request for a recipient account at the issuer computer has been approved or declined.

The term “settlement message” may refer to a message that is generated and transmitted as part of transaction processing. Settlement files are typically sent in order for a merchant to receive funds for authorized financial transactions. A typical settlement message may include a batch record containing one or more settlement records, where each settlement record contains payment information for authorized financial transactions. Settlement messages may be generated by a merchant computer or issuer computer or any other appropriate computer apparatus. In some embodiments, a settlement message may also be sent by a payment processing network, or other party within a transaction system, to receive funds from or send funds to an issuer. Settlement records within the settlement message are generally for credit card, debit card, or prepaid card transactions.

Settlement messages are typically submitted for processing after the close of business for a merchant. In some embodiments, settlement messages can also be submitted for processing throughout the day (e.g., in real time) or can be submitted when the value of the transactions in the settlement message reaches a predetermined threshold for processing. In some embodiments, settlement messages may be a message requesting monetary funds in the amount of a transaction conducted by a user at a merchant.

The term “transaction” may refer to a transfer of value between two users (e.g. individuals or entities). A transaction may involve the exchange of goods or services for monetary funds between two users. A typical transaction, as contemplated by embodiments of the claimed invention, involves the transfer of funds from a first account associated with a first payment device to a second account associated with a second payment device. In other embodiments, a transaction may involves an individual or entity purchasing goods or services from a merchant or other entity in exchange for monetary funds.

The term “funding amount” may refer to an amount of monetary funds, and may include any suitable types of value including U.S. dollars, British pounds, Euros, virtual currency (e.g. BitCoin), etc. The funding amount may also be referred to as a transaction amount, transfer amount, or amount of funds.

The term “apportionment rules” may refer to one or more rules related to dividing funds. In some embodiments, when a prepaid card holder wants to receive cash in exchange for an account value of the prepaid card, a merchant associated with the prepaid card may define rules for apportioning the account value of a prepaid card between the merchant and the prepaid card holder. For example, a first merchant may define an apportionment rule whereby 80% of the funds associated with the prepaid card are returned to the prepaid card holder, while the remaining 20% is not returned to the prepaid card holder. A second merchant may define an apportionment rule whereby the prepaid card holder receives 50% of the funds associated with the prepaid card. In embodiments of the invention, any apportionment scheme may be possible.

The term “user” may refer to an individual or entity. The user may be a consumer or business who is associated with a financial account and whose financial account can be used to conduct financial transactions using a payment device associated with the financial account.

The term “initiating” may refer to either the first steps taken in order to begin a process or the steps conducted in order to complete a process. For example, “initiating a transfer of funds for the transaction amount from a first account at the first issuer to a second account at the second issuer” can refer to the actual process required to transfer funds from the first account to the second account. However, “initiating a transfer of funds for the transaction amount from a first account at the first issuer to a second account at the second issuer” can also refer to the process of sending a message from the mobile device to the payment processing network, or from the payment processing network to the issuer computers, with instructions for transferring funds from the first account to the second account.

The term “password” may refer to a unique expression that uniquely identifies a user. The password may be created by the user and submitted via a mobile device to the payment processing network. In other embodiments, the password could be created by the payment processing network, or by an application associated with a reader device, on behalf of the user. The password may be alphanumeric, or composed of only numbers or only letters. Passwords are not limited to strings of characters.

The password may be an example of a “user identifier”. Other examples of user identifiers comprise a personal identification number (PIN), a unique visual image or pattern, a voice pattern, or another unique configuration of letters and/or numbers. Embodiments of the invention may use user identifier request messages and user identifier response messages for verifying the identity of the user.

The term “server computer” may include a powerful computer or cluster of computers. For example, the server computer can be a large mainframe, a minicomputer cluster, or a group of servers functioning as a unit. In one example, the server computer may be a database server coupled to a Web server. The server computer may be coupled to a database and may include any hardware, software, other logic, or combination of the preceding for servicing the requests from one or more client computers. The server computer may comprise one or more computational apparatuses and may use any of a variety of computing structures, arrangements, and compilations for servicing the requests from one or more client computers.

The term “issuer computer” may refer to a party to a financial transaction. An issuer computer is typically a business entity (e.g. a bank) which maintains financial accounts for a plurality of users. The issuer computer can generate verify enrollment response messages and payer authentication response messages as a party to an authentication process for a user and a transaction. An issuer computer may also be referred to as an authorization system.

### I. Systems

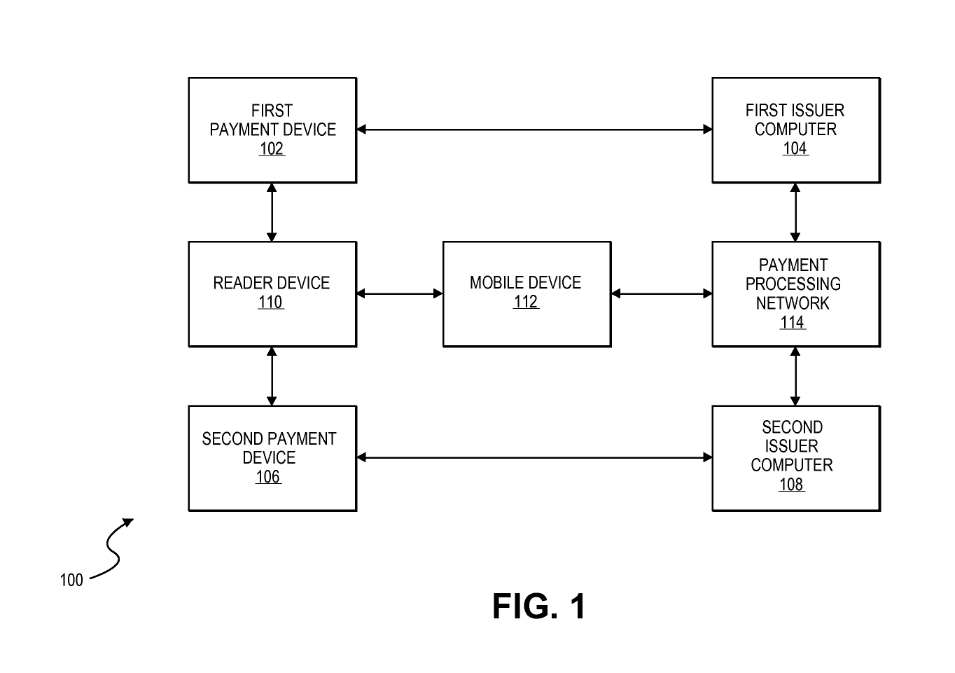

A system 100 for conducting and processing value transfers according to an embodiment of the present invention is shown with reference to FIG. 1.

An exemplary system 100 for conducting value transfers between payment devices can be seen in FIG. 1. For simplicity of illustration, a certain number of components are shown is shown in FIG. 1. It is understood, however, that embodiments of the invention may include more than one of each component. In addition, some embodiments of the invention may include fewer than all of the components shown in FIG. 1. In addition, the components in FIG. 1 may communicate via any suitable communication medium (including the internet), using any suitable communication protocol.

The system 100 may include a first payment device 102, a first issuer computer 104, a second payment device 106, a second issuer computer 108, a reader device 110, a mobile device 112, and a payment processing network 114. In some embodiments, the first payment device 102 and the second payment device 106 may include a first account identifier and a second account identifier, respectively. Such account identifiers may be stored in computer readable media in the first and second payment devices.

The first payment device 102 and the second payment device 106 may be in any suitable form. For example, suitable payment devices can be hand-held and compact so that it can fit into a user's wallet and/or pocket (e.g., pocket-sized). The payment devices can include a processor, and memory, input devices, and output devices, operatively coupled to the processor. Specific examples of payment devices include debit devices (e.g., a debit card), credit devices (e.g., a credit card), or stored value devices (e.g., a prepaid or stored value card). The payment devices can also be cellular or wireless phones, personal digital assistants (PDAs), pagers, tablet computers, portable computers, smart cards, and the like.

In some embodiments, a first user may be associated with the first payment device 102, and a second user may be associated with the second payment device 106. In other embodiments, both the first payment device 102 and the second payment device 106 may be associated with the same user. A user may be an individual, or an organization such as a business, that is capable of conducting transactions for goods or services. The user may further be an individual or business that has established a financial account with a financial institution. The typical user is a user engaging in a transaction with a merchant for merchant goods and/or services, or to transfer funds between payment devices (102 and 106).

The reader device 110 may be a device that can be configured to read and obtain data from the first payment device 102 and the second payment device 106. In some embodiments, the reader device 110 may be a portable reader device that is configured to connect with a mobile device 112, or other computing device. In such embodiments, the reader device 110 may be physically connected to the mobile device 112 via a connector portion, or may be connected to the mobile device via a wireless connection (e.g., Bluetooth™). In such embodiments, the portable reader device 110 may be connected to the mobile device 112 when the portable reader device 110 is needed to read a payment device (102 and 106), and otherwise physically disconnected from the mobile device 112 when not required. In other embodiments, the reader device 110 may be embedded or contained within the mobile device 112 and accessed via the mobile device 112.

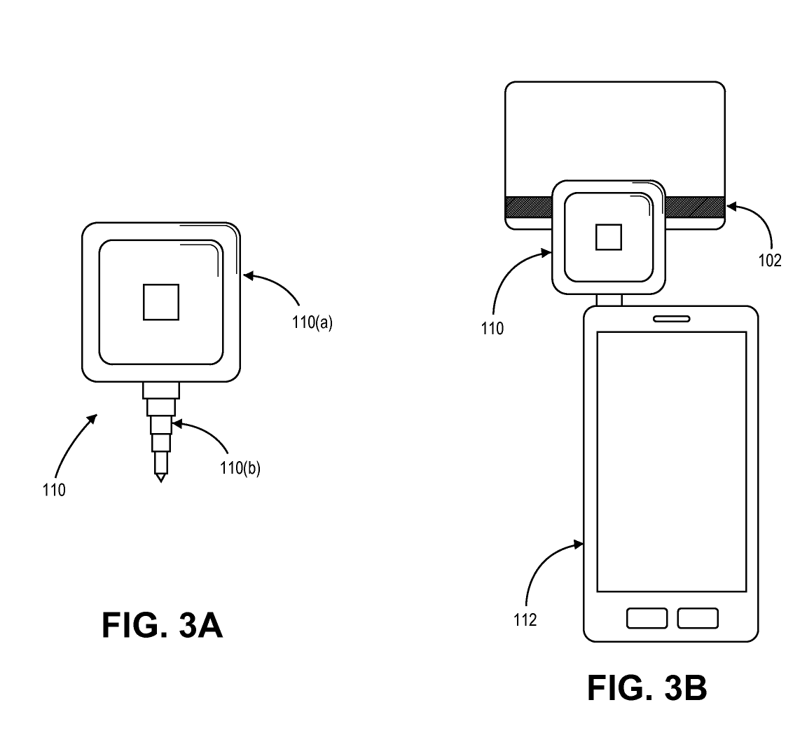

FIG. 3A shows a block diagram of an exemplary portable reader device 110 according to an embodiment of the invention. The portable reader device 110 may be comprised of a main body portion 110(a) and a connector portion 110(b). In some embodiments, when the portable reader device 110 is connected to the mobile device 112, either via a direct connection using the connector portion 110(b) or via a wireless connection, the mobile device 112 may be able to access the services provided by the portable reader device 110. The services may be accessed via an application stored on a memory in the portable reader device 110 or via an application stored on a memory in the mobile device 112.

In some embodiments, the portable reader device 110 is a portable magnetic stripe reader device 110 that reads a magnetic stripe portion of a payment device (102 and 106) when the magnetic stripe portion is passed (e.g., swiped) through the portable magnetic stripe reader device 110. The portable reader device 110 may also read data from a contactless element of the payment device (102 and 106) when the payment device (102 and 106) is passed within proximity of the reader device 110

FIG. 3B shows an example of a payment device 102 in the form of a card. As shown, the payment device 102 may comprise a plastic substrate. In some embodiments, a contactless element for interfacing with an access device (e.g., the reader device 110, a point of sale device) may be present on, or embedded within, the plastic substrate. Consumer information such as an account number, expiration date, and/or a user name may be printed or embossed on the card. A magnetic stripe portion may also be on the plastic substrate. In some embodiments, the payment device 102 may include one or both of the magnetic stripe portion and the contactless element. In some embodiments, the payment device 102 may comprise a microprocessor and/or memory chips with user data stored in them.

As shown in FIG. 3B, the main body portion 110(a) may be configured to interact with the payment device 102 when the magnetic stripe portion of the payment device 102 is swiped through the portable reader device 110.

In other embodiments, the portable reader device 110 is a portable contactless reader device 110. In such embodiments, the portable reader device 110 may be configured to interact with a contactless element on the payment device 102 when the payment device (102 and 106) is in proximity to the portable contactless reader device 110.

In other embodiments, the reader device 110 may be embedded within a mobile device 112, or other computing device. In such embodiments, the reader device 110 may be activated by the mobile device 112 when needed. For example, a user can launch an application stored on the mobile device 112 to activate features of the reader device 110.

The reader device 110 may be configured to read and obtain data from payment devices (102 and 106) when the payment devices (102 and 106) are placed within proximity to the reader device 110. In some embodiments, the reader device is configured to read and obtain data from a magnetic stripe portion embedded on a payment device (102 or 106). The magnetic stripe portion may contain financial data for an account associated with the payment device (102 or 106). In some embodiments, the reader device 110 may be configured to read and obtain data from payment devices (102 and 106) when the payment devices come into contact with the reader device 110 (e.g., the magnetic stripe of the payment device is swiped through a portion of the reader device 110).

The reader device 110 may further comprise a memory portion. In some embodiments, the memory portion of the reader device 110 may be used to store an application used to conduct funds transfers and prepaid card consolidations are described in embodiments of the claimed invention. Further, the memory may store registration data for the user and mobile device 112, and financial data for financial accounts and payment devices that may have been previously used for transactions utilizing the reader device 110.

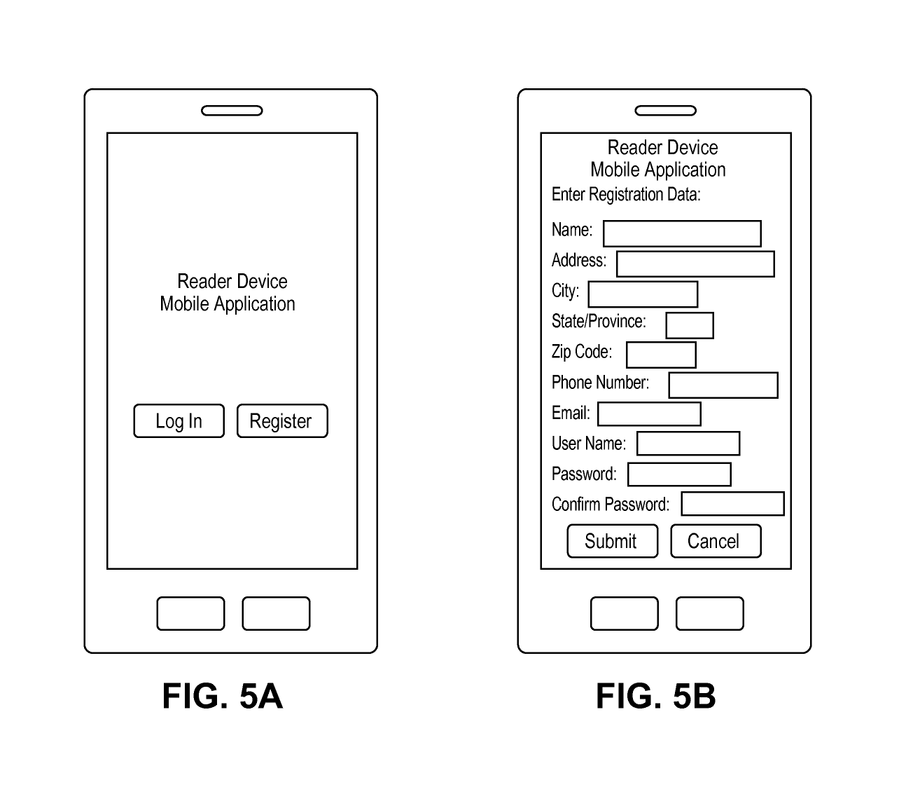

The mobile device 112 may be a device that is may be used as part of a process to conduct a transaction, such as a transfer of funds from the first payment device 102 to the second payment device 106. The mobile device 112 may be capable of conducting communications over a network. A mobile device 112 may be in any suitable form. For example, suitable mobile devices 112 can be hand-held and compact so that it can fit into a user's wallet and/or pocket (e.g., pocket-sized). The mobile device 112 can include a processor, and memory, input devices, and output devices, operatively coupled to the processor. Specific examples of mobile devices 112 include cellular or mobile phones, personal digital assistants (PDAs), pagers, portable computers, smart cards, and the like. In some embodiments, the display 112(d) of mobile device 112 may be a user interface that may allow the user to select or interact with objects presented on the display 112(d), including, but not limited to menus, text fields, icons, and keys/inputs on a virtual keyboard. The display 112(d) may be configured to present an application (e.g., a value transfer application), as shown in FIGS. 5A-5B, 7A-7C, 9A-9C, 11A-11C, and 14A-14G.

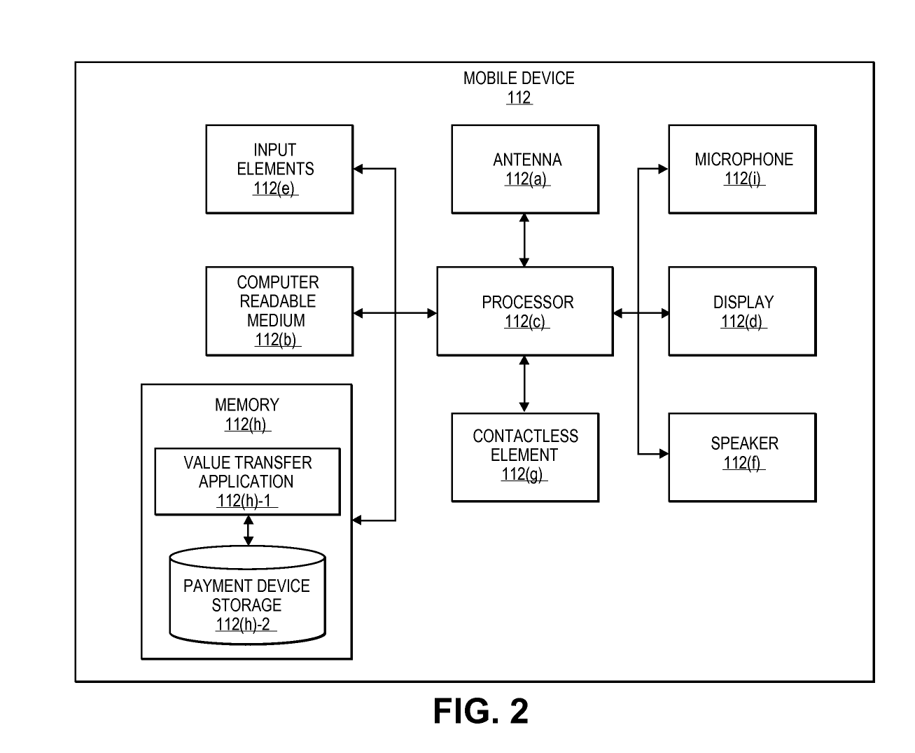

FIG. 2 shows a block diagram of an exemplary mobile device 112. It should be appreciated that mobile device 112, and any other mobile devices mentioned herein can include some or all of the components of mobile device 112. The exemplary mobile device 112 may comprise a computer-readable medium 112(b) and a body. The computer-readable medium 112(b) may be present within the body, or may be detachable from it. The body may be in the form a plastic substrate, housing, or other structure. The computer-readable medium 112(b) may be a memory, such as a tangible (i.e. physical or durable) memory that stores data and may be in any suitable form including a hard drive, magnetic stripe, a memory chip, uniquely derived keys (such as those described above), encryption algorithms, etc.

The mobile device 112 may further include a contactless element 112(g), which is typically implemented in the form of a semiconductor chip (or other data storage element) with an associated wireless transfer (e.g., data transmission) element, such as an antenna 112(a). Data or control instructions transmitted via a cellular network may be applied to the contactless element 112(g) by means of a contactless element interface (not shown). The contactless element interface may function to permit the exchange of data and/or control instructions between the mobile device circuitry (and hence the cellular network) and an optional contactless element 112(g).

The contactless element 112(g) may be capable of transferring and receiving data using a near field communications (“NFC”) capability (or near field communications medium) typically in accordance with a standardized protocol or data transfer mechanism (e.g., ISO 14443/NFC). Near field communications capability is a short-range communications capability, such as RFID, Bluetooth™, infra-red, or any other suitable data transfer capabilities that can be used to exchange data between the mobile device 112 and an interrogation device. Thus, the mobile device 112 may be capable of communicating and transferring data and/or control instructions via both cellular network and near field communications capability.

The mobile device 112 may also include a processor 112(c) (e.g., a microprocessor or a group of processors working together) for processing the functions of the mobile device 112 and a display 112(d) to allow a user to send and receive messages with the authentication platform, as well as to view phone numbers and other information and messages. The mobile device 112 may further include input elements 112(e) to allow a user to input information into the device (e.g. a physical or virtual keyboard), a speaker 112(f) to allow the user to hear voice communication, music, etc., and a microphone 112(i) to allow the user to transmit her voice through the mobile device 112. The mobile device 112 may also include an antenna 112(a) for wireless data transfer (e.g., data transmission).

The mobile device 112 may also include a memory portion 112(h). In some embodiments, the memory portion may include a value transfer application (ir “application”) 112(h)-1. The value transfer application 112(h)-1 may be configured to launch when the reader device 110 is connected to the mobile device 112 (either physically or via a wireless connection). In other embodiments, the value transfer application 112(h)-1 may be configured to launch when the user selects the value transfer application 112(h)-1 for activation (e.g., by selecting an icon or link associated with the value transfer application 112(h)-1). The memory portion 112(h) may further include a payment device storage database 112(h)-2 storing payment device data for one or more payment devices. For example, the payment device storage database 112(h)-2 may include all payment devices or payment accounts (e.g., bank routing number, account number) that have been registered or associated with the value transfer application 112(h)-1.

The payment processing network 114 may have or operate at least a server computer. In some embodiments, the server computer may be coupled to a database and may include any hardware, software, other logic, or combination of the preceding for servicing the requests from one or more client computers. The server computer may comprise one or more computational apparatuses and may use any of a variety of computing structures, arrangements, and compilations for servicing the requests from one or more client computers.

The payment processing network 114 may include data processing subsystems, networks, and operations used to support and deliver authorization services, exception file services, and clearing and settlement services. An exemplary payment processing network may include VisaNet™. Networks that include VisaNet™ are able to process credit card transactions, debit card transactions, and other types of commercial transactions. VisaNet™, in particular, includes an integrated payments system (Integrated Payments system) which processes authorization requests and a Base II system, which performs clearing and settlement services. The payment processing network 114 may use any suitable wired or wireless network, including the Internet.

The payment processing network 114 may be used to initiate the transfer of funds for the transaction amount (or funding amount) from the first account at the first issuer (identified by the first account identifier) to the second account at the second issuer (identified by the second account identifier). The payment processing network 114 may evaluate the message received from the mobile device 112 to determine a first issuer associated with the first account identifier and a second issuer associated with the second account identifier. The payment processing network 114 may process request and response messages and determine the appropriate destination for the request and response messages. For example, the payment processing network may generate a request message (e.g., a AFT request message) to the first issuer computer 104 the includes a debit request to debit funds from a first account, and also may generate a request message (e.g., an OCT request message) to the second issuer computer 108 that includes a credit request to credit the funds to a second account.

A request message can be a message sent requesting that issuer computers (104 and 108) authorize a financial transaction. A request message may comply with ISO 8583, which is a standard for systems that exchange electronic transactions made by users using payment devices. A request message according to other embodiments may comply with other suitable standards. In some embodiments, the authorization request message may include, among other data, an account identifier (e.g., Primary Account Number (PAN), token, QR code), user identification data, and a transaction amount or funds transfer amount. In some embodiments, the request message is generated by a server computer in the payment processing network 114.

A response message can be a message sent from the issuer computers (104 and 108), in response to the request message to approve or decline a financial transaction or funds transfer. In some embodiments, the funds transfer may be declined if an account has insufficient funds to perform the funds transfer. A response message may comply with ISO 8583, which is a standard for systems that exchange electronic transactions made by users using payment devices.

The payment processing network may also handle the clearing and settlement of transactions. The payment processing network may authenticate user information and organize the settlement process of user accounts between the first issuer computer 104 and the second issuer computer 106. An exemplary system for clearing and settlement is the Base II data processing system, which provides clearing, settlement, and other interchange-related services.

### II. Methods

Methods according to embodiments of the invention can be described with respect to FIGS. 1-18.

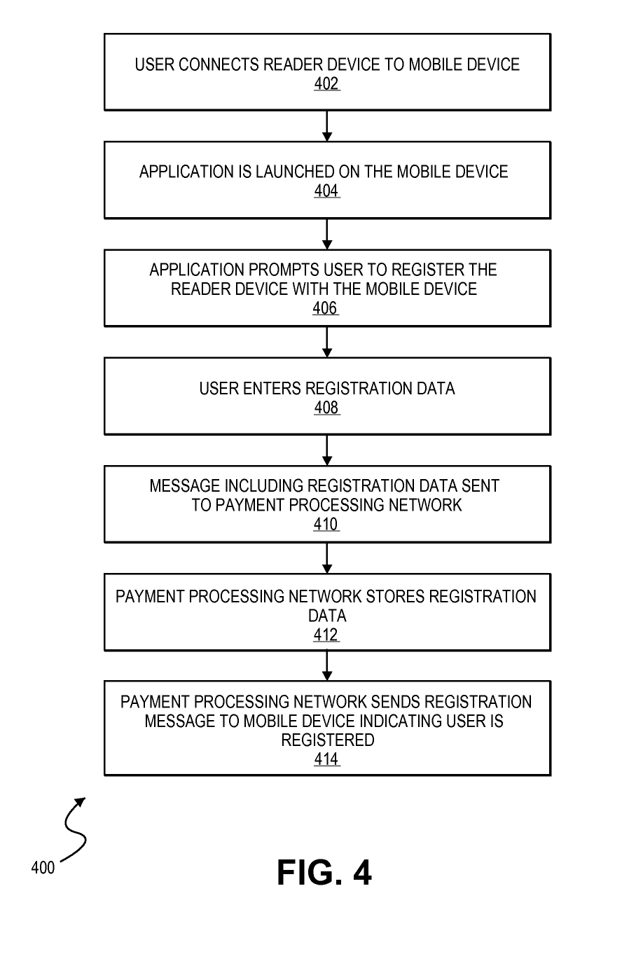

FIG. 4 is a flowchart describing the process of registering a reader device for enrollment in a value transfer system according to an embodiment of the invention. The process will be described with reference to an embodiment of the invention depicted in FIGS. 5A and 5B.

In step 402, a user connects the reader device 110 to the mobile device 112. In some embodiments, the user may connect the reader device 110 to the mobile device 112 by inserting a connector portion 110(b) into a port (e.g., a 3.5 mm TRS or TRRS socket, USB port, or other physical interface) in the mobile device 112. A physical connection is depicted in FIG. 3B. In other embodiments, where the reader device 110 and the mobile device 112 are part of a single device, connecting the reader device 110 to the mobile device 112 may be accomplished by accessing an application on the mobile device 112, by engaging switch on the mobile device 112 from an “OFF” to “ON” position, or by any other comparable means of activating a device.

Connecting the reader device 110 to the mobile device 112 may be a physical connection (e.g., inserting into a 3.5 mm TRS or TRRS socket, USB port, or other physical interface) or a wireless connection (e.g., by a Bluetooth™ connection or other suitable wireless connections that allow the transfer of data). In wireless embodiments, the reader device 110 may be connected to the mobile device 112 when the devices are moved within a predetermined range of each other.

In step 404, an application is launched on the mobile device 112. In some embodiments, a value transfer application may be launched on a display of the mobile device 112. In some embodiments, the value transfer application may be automatically launched when the reader device 110 and the mobile device 112 are connected. In other embodiments, the application may be launched by the user selecting an application on the display of the mobile device 112.

In step 406, the application prompts the user to register the reader device 110 with the mobile device 112. When the application is launched on the mobile device 112, the user may be prompted to either provide login data (e.g., user name, password) or register the mobile device 112 with the reader device 110, as depicted in FIG. 5A. In other embodiments, when the reader device 110 and the mobile device 112 are connected for the first time, the registration page may be automatically displayed on the mobile device 112. One example of a registration page is shown in FIG. 5B. As shown in FIG. 5B, the registration page may request the user's name, address, phone number, email address, and a desired user name and password. Other embodiments of the registration page may require less data or more data than the registration page depicted in FIG. 5B.

In step 408, the user enters registration data. In one embodiment, the user may provide the registration data as required by the reader device 110 by selecting each field (e.g., drop down menu, text box), as shown in FIG. 5B, and providing the appropriate response. In other embodiments, the user may perform the registration on a different computing device and when prompted provide the appropriate login data. When the user has entered all the required registration data, the user can submit the data or cancel the registration process.

In step 410, a message including the registration data is sent to a payment processing network 114. When the user submits the registration data, the application on the mobile device 112 may generate a data message containing the provided registration data. The data message may then be sent to the payment processing network 114. The data message may be sent by any appropriate communications means, including as data packets transmitted across a wireless communications network (e.g., the Internet), or via SMS text messaging. The data message may be sent over a transport layer security (TLS) or secure socket layer (SSL) connection. In some embodiments, the data message may be encrypted prior to being sent to the payment processing network 114 to ensure that the secure data cannot be easily intercepted and used without knowledge of a key used to encrypt and decrypt the data message.

The payment processing network 114 may evaluate and analyze the registration data included in the data message. This evaluation may include decrypting the data message and parsing through the data contained in the data message.

In step 412, the payment processing network 114 stores the registration data. After the payment processing network 114 has analyzed the registration data in the data message, the payment processing network 114 may store the registration data in a database of registered users or devices. A unique user profile may also be generated for the user to store data associated with the user (e.g., transaction history, accounts data, preferences). The registration data may be stored with other accounts registered with the value transfer application using other reader devices 110.

In step 414, the payment processing network 114 sends a registration message to the mobile device 112 indicating that the user is registered. In some embodiments, the payment processing network 114 may notify the user of the successful (or unsuccessful) registration of the user. The notification may be sent via a data message from the payment processing network 114 to the application on the mobile device 112. In other embodiments, the notification may be in the form of an SMS text message, an electronic mail message, an automated telephone call, or any other suitable means.

In some embodiments, once the user has registered the reader device 110, the reader device 110 may be uniquely paired with the mobile device 112 so that the reader device 110 may only function with the mobile device 112 used to register the reader device. In such embodiments, when the reader device 110 is connected with a different mobile device 112 than the one used in the registration process, the reader device 110 may become locked to prevent the theft of any financial data stored on the reader device 110.

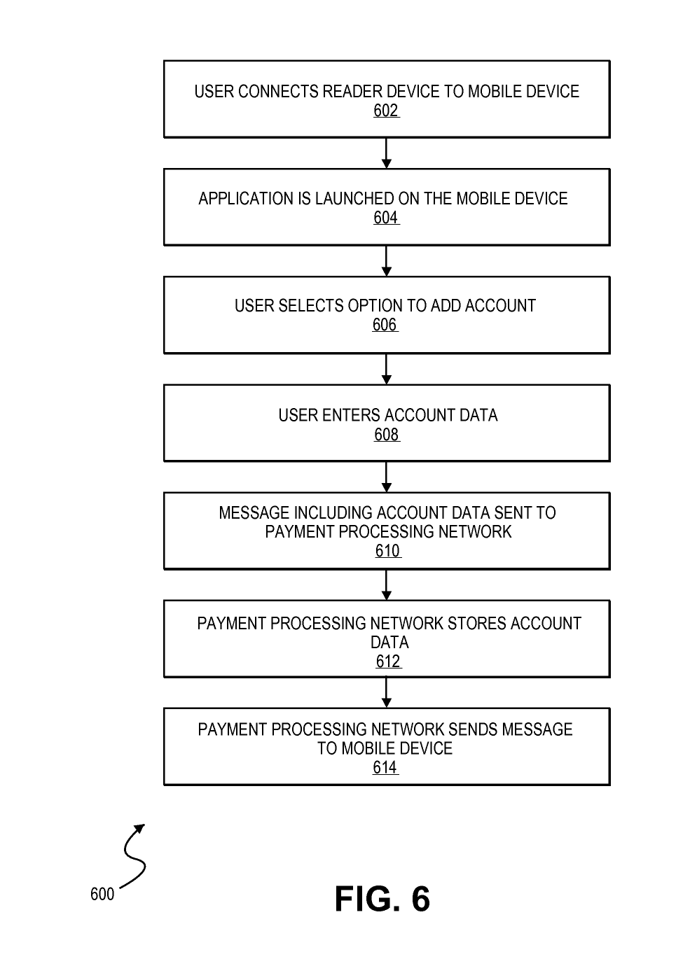

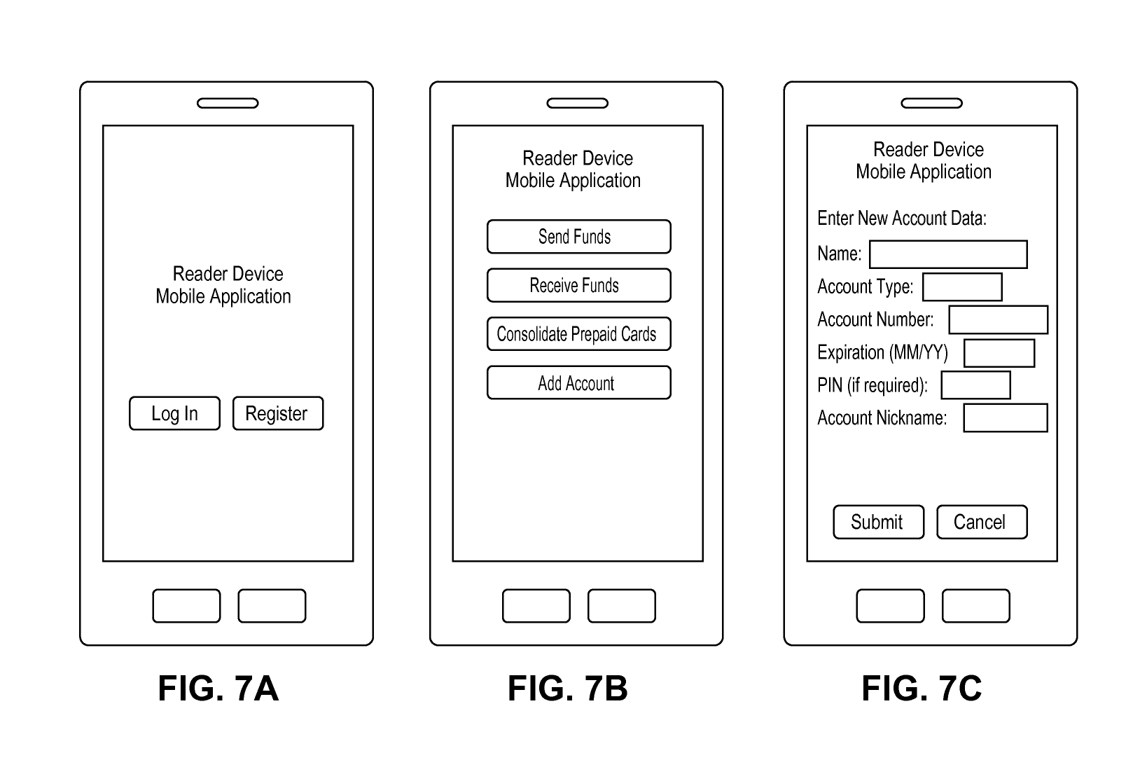

FIG. 6 is a flowchart describing the process of adding an account for use in a value transfer system according to an embodiment of the invention. The process will be described with reference to an embodiment of the invention depicted in FIGS. 7A-7C.

In step 602, a user connects the reader device 110 to the mobile device 112. In some embodiments, the user may connect the reader device 110 to the mobile device 112 by inserting a connector portion 110(b) into a port (e.g., a 3.5 mm TRS or TRRS socket, USB port, or other physical interface) in the mobile device 112. A physical connection is depicted in FIG. 3B. In other embodiments, where the reader device 110 and the mobile device 112 are part of a single device, connecting the reader device 110 to the mobile device 112 may be accomplished by accessing an application on the mobile device 112, by engaging switch on the mobile device 112 from an “OFF” to “ON” position, or by any other comparable means of activating a device.

Connecting the reader device 110 to the mobile device 112 may also be a physical connection (e.g., inserting into a 3.5 mm TRS or TRRS socket, USB port, or other physical interface) or a wireless connection (e.g., by a Bluetooth™ connection or other suitable wireless connections that allow the transfer of data). In wireless embodiments, the reader device 110 may be connected to the mobile device 112 when the devices are moved within a predetermined range of each other.

In step 604, an application is launched on the mobile device 112. In some embodiments, a value transfer application may be launched on a display of the mobile device 112. In some embodiments, the value transfer application may be automatically launched when the reader device 110 and the mobile device 112 are connected. In other embodiments, the application may be launched by the user selecting an application on the display of the mobile device 112.

In step 606, the user selects an option to add an account. When the application is launched on the mobile device 112, the user may be prompted to either provide login data (e.g., user name, password) or register the mobile device 112 with the reader device 110, as depicted in FIG. 7A. After providing correct login data, the user may then be presented with an options menu, as depicted in FIG. 7B. In some embodiments, where the reader device 110 was previously registered, the application may automatically launch with the options menu, without requiring the user to provide login data. In such embodiments, once the user has registered the reader device 110 with the mobile device 112, the reader device 110 may be uniquely paired with the mobile device 112. Other embodiments of the invention contemplate other means of providing secure access to the functionality of the reader device 110 and the associated financial data as would be understood by one of ordinary skill in the art.

In some embodiments, the options menu presented by the value transfer application may include options to “Send Funds”, “Receive Funds”, “Consolidate Prepaid Cards”, or “Add Account”. Other embodiments may include additional or fewer options than those depicted in FIG. 7B.

In step 608, the user enters account data. In one embodiment, the user may provide account data as required by the reader device 110 by selecting each field (e.g., drop down menu, text box), as shown in FIG. 7C, and providing the required information. As shown in FIG. 7C, the new account page may request the name for the account (e.g., the name displayed on the face of a payment device), an account type (e.g., VISA, MasterCard, American Express, Discover, checking account, savings account) account number, expiration date, pin or CVV (if required), and a user determined account nickname. When the account type of a checking account or savings account is selected, the new account page may also display fields for a bank routing number as well as an account number. Other embodiments of the new account page may require less data or more data than the new account page depicted in FIG. 7C. When the user has entered all the required account data, the user can submit the data or cancel the “Add Account” process.

In step 610, a message including the account data is sent to a payment processing network 114. When the user submits the new account data, the application on the mobile device 112 may generate a data message containing the provided new account data. The data message may then be sent to the payment processing network 114. The data message may be sent by any appropriate communications means, including as data packets transmitted across a wireless communications network (e.g., the Internet), or via SMS text messaging. The data message may be sent over a transport layer security (TLS) or secure socket layer (SSL) connection. In some embodiments, the data message may be encrypted prior to being sent to the payment processing network 114 to ensure that the secure data cannot be easily intercepted and used without knowledge of a key used to encrypt and decrypt the data message.

In step 612, the payment processing network 114 stores the account data. The payment processing network 114 may determine an appropriate issuer associated with the new account data. The payment processing network 114 may also send a message to the appropriate issuer to determine if the new account data Is valid. After the payment processing network 114 has analyzed the new account data in the data message, the payment processing network 114 may store the new account data in a database. The new account data may be stored in a user profile generated for the user during the registration process. If the payment processing network 114 determines that the new account data is invalid (e.g., incorrect account number, incorrect pin), the new account data may not be added to the user profile.

In step 614, the payment processing network 114 sends a message to the mobile device 112 indicating that the account has been added. In some embodiments, the payment processing network 114 may notify the user that the account has been added to the user's profile. The notification may be sent via a data message from the payment processing network 114 to the application on the mobile device 112. In other embodiments, the notification may be in the form of an SMS text message, an electronic mail message, an automated telephone call, or any other suitable messaging means.

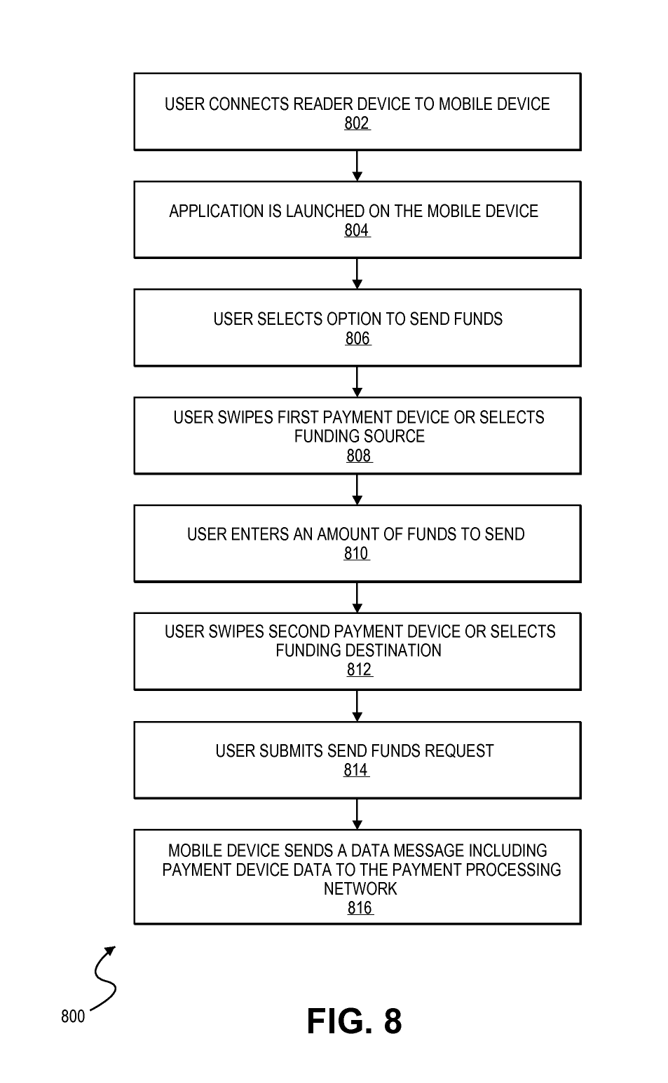

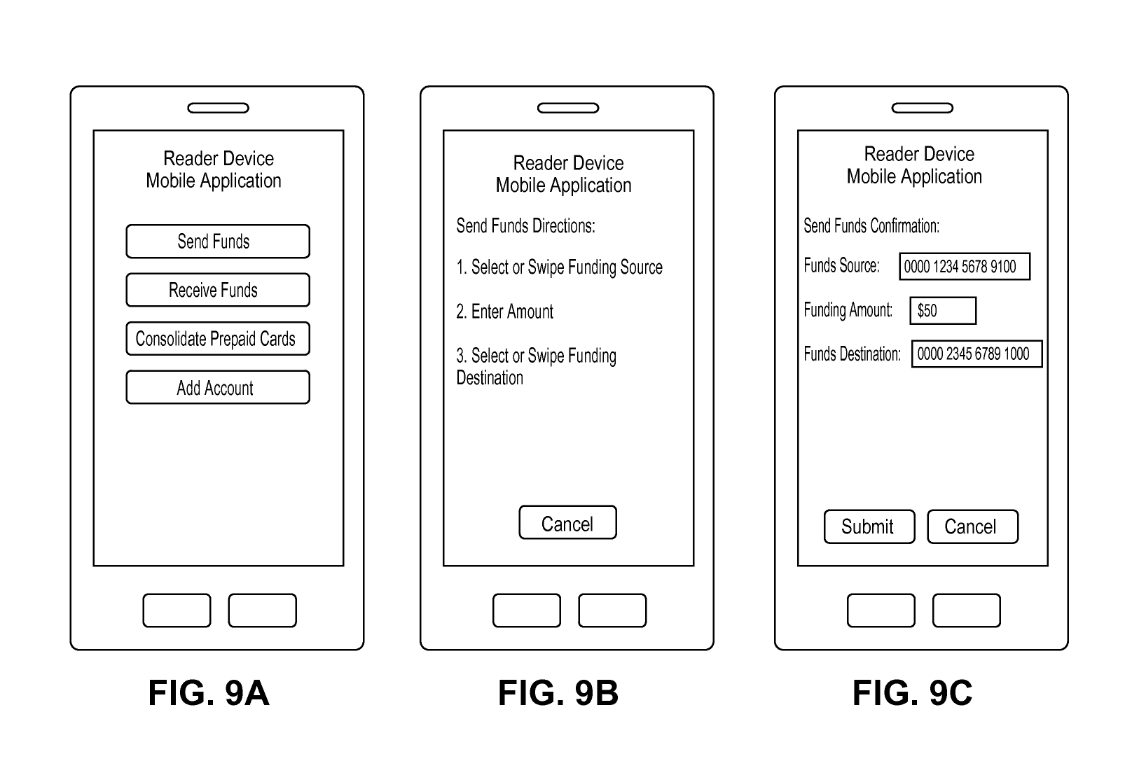

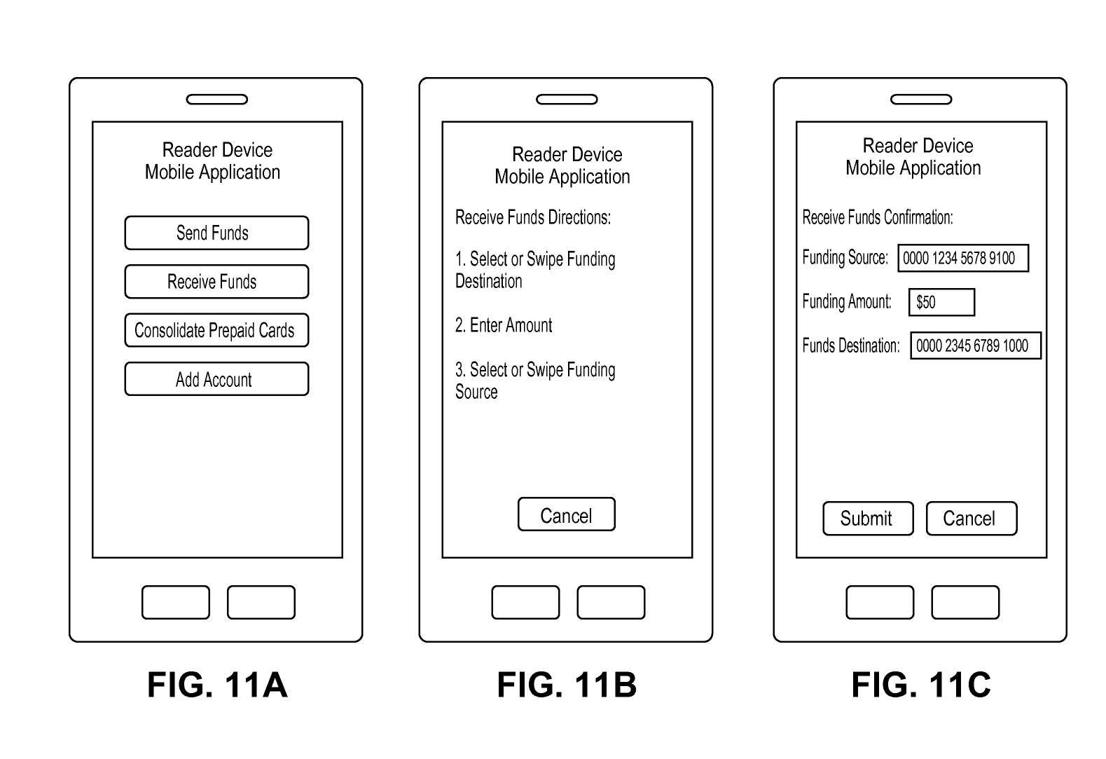

FIG. 8 is a flowchart describing the process of sending funds using a value transfer system according to an embodiment of the invention. The process will be described with reference to an embodiment of the invention depicted in FIGS. 9A-9C. The process, as described below, may be performed in a similar manner for a receive funds request, as depicted in FIGS. 11A-11C, where the first payment device 102 is the funding destination and the second payment device 106 is the funding source.

In step 802, a user connects the reader device 110 to the mobile device 112. In some embodiments, the user may connect the reader device 110 to the mobile device 112 by inserting a connector portion 110(b) into a port (e.g., a 3.5 mm TRS or TRRS socket, USB port, or other physical interface) in the mobile device 112. A physical connection is depicted in FIG. 3B. In other embodiments, where the reader device 110 and the mobile device 112 are part of a single device, connecting the reader device 110 to the mobile device 112 may be accomplished by accessing an application on the mobile device 112, by engaging switch on the mobile device 112 from an “OFF” to “ON” position, or by any other comparable means of activating a device.

Connecting the reader device 110 to the mobile device 112 may also be a physical connection (e.g., inserting into a 3.5 mm TRS or TRRS socket, USB port, or other physical interface) or a wireless connection (e.g., by a Bluetooth™ connection or other suitable wireless connections that allow the transfer of data). In wireless embodiments, the reader device 110 may be connected to the mobile device 112 when the devices are moved within a predetermined range of each other.

In step 804, an application is launched on the mobile device 112. In some embodiments, a value transfer application may be launched on a display of the mobile device 112. In some embodiments, the value transfer application may be automatically launched when the reader device 110 and the mobile device 112 are connected. In other embodiments, the application may be launched by the user selecting an application on the display of the mobile device 112.

In step 806, the user selects an option to send funds to an account. When the application is launched on the mobile device 112, the user may be prompted to either provide login data (e.g., user name, password) or register the mobile device 112 with the reader device 110, as depicted in FIG. 7A. After providing correct login data, the user may then be presented with an options menu, as depicted in FIG. 9A. In some embodiments, the options menu presented by the value transfer application may include options to “Send Funds”, “Receive Funds”, “Consolidate Prepaid Cards”, or “Add Account”. Other embodiments may include additional or fewer options than those depicted in FIG. 9A.

The user may then select the “Send Funds” option from the options menus in FIG. 9A. The user may then be provided with instructions for conducting a “Send Funds” process, as depicted in FIG. 9B.

In step 808, the user swipes a first payment device 102 or selects a funding source. In some embodiments, the reader device 110 receives a first account identifier from the first payment device 102 when the first payment device 102 is passed through (e.g., swiped or moved in proximity to) the reader device 110. As the first payment device 102 is passed through the reader device 110, the reader device 110 may read a magnetic stripe portion of the first payment device 102 containing financial data, including the first account identifier. In other embodiments, the user may select a funding source from a list of funding sources (e.g., checking account, savings account or a stored payment device) previously added via a value transfer application stored on the reader device 110 or on the mobile device 112.

In some embodiments, after the first payment device 102 is swiped through the reader device 110, the reader device 110 may generate a data message including the first account identifier and send the data message to the mobile device 112. The data message may be sent from the reader device 110 to the mobile device 112 via the connector portion 110(b) connected with the mobile device 112. In other embodiments, where the mobile device 112 and the reader device 110 are a single device, the first account identifier may be accessed from a memory portion accessible by both the mobile device 112 and the reader device 110.

In step 810, the user enters an amount of funds to send. After the reader device 110 has read the first account identifier and other financial data from the first payment device 102, the user may be prompted to enter an amount of funds to debit from a first account associated with the first account identifier. In some embodiments, the user may be prompted by the application with a field to provide the amount of funds to send via a virtual keyboard on the mobile device 112.

In step 812, the user swipes a second payment device 106 or selects a funding destination. In some embodiments, the reader device 110 receives a second account identifier from the second payment device 106 when the second payment device 106 is passed through (e.g., swiped or moved in proximity to) the reader device 110. As the second payment device 106 is passed through the reader device 110, the reader device 110 may read a magnetic stripe portion of the second payment device 106 containing financial data, including the first account identifier. In other embodiments, the user may select a funding source from a list of funding sources previously added via a value transfer application stored on the reader device 110 or on the mobile device 112.

In some embodiments, after the second payment device 106 is swiped through the reader device 110, the reader device 110 may generate a data message including the second account identifier and send the data message to the mobile device 112. The data message may be a signal sent from the reader device 110 to the mobile device 112 via the connector portion 110(b) connected with the mobile device 112. The signal may be an electrical signal that may be transmitted over a connection (e.g., the connector portion 110(b)) that may commonly be used to carry electrical audio signals. In other embodiments, where the mobile device 112 and the reader device 110 are a single device, the second account identifier may be accessed from a memory portion accessible by both the mobile device 112 and the reader device 110.

In some embodiments, the reader device 110 generates and sends a single data message including both the first account identifier and the second account identifier. In other embodiments, the reader device 110 may generate and send two data messages, each one including one of the first account identifier and the second account identifier. In such embodiments, the first account identifier and the second account identifier may be stored in a memory portion of the reader device 110 prior to sending the data message to the mobile device 112.

In a Send Funds process (and a Receive Funds process), the data message may be for transferring funds between the first account associated with the first account identifier and the second account associated with the second account identifier. The data message may be formatted in any suitable manner that may be understood by the reader device 110 and the mobile device 112.

In step 814, the user submits a send funds request. After the user has swiped the first payment device 102 and the second payment device 106 with the reader device 110, the mobile device 112 may display a summary of the Send Funds process, including the first account identifier (representing the “funding source”), a funding amount, and the second account identifier (representing the “funds destination”). One example of a Send Funds summary screen, as presented by the application, is depicted in FIG. 9C. In the example shown, the first and second account identifiers are 16 digits numeric sequences. These may represent account numbers, pseudo-account numbers, or unique identifiers that may be used by the payment processing network 114 to determine true accounts data.

In step 816, the mobile device 112 sends a data message including the data for the first payment device 102 and the second payment device 106 to the payment processing network 112. When the user submits the Send Funds request, the application on the mobile device 112 may generate a data message containing the received first account identifier, second account identifier, and funding amount. The data message may then be sent to the payment processing network 114. The data message may be sent by any appropriate communications means, including as data packets transmitted across a wireless communications network (e.g., the Internet), or via SMS text messaging. The data message may be sent over a transport layer security (TLS) or secure socket layer (SSL) connection. In some embodiments, the data message may be encrypted prior to being sent to the payment processing network 114 to ensure that the secure data cannot be easily intercepted and used without knowledge of a key used to encrypt and decrypt the data message.

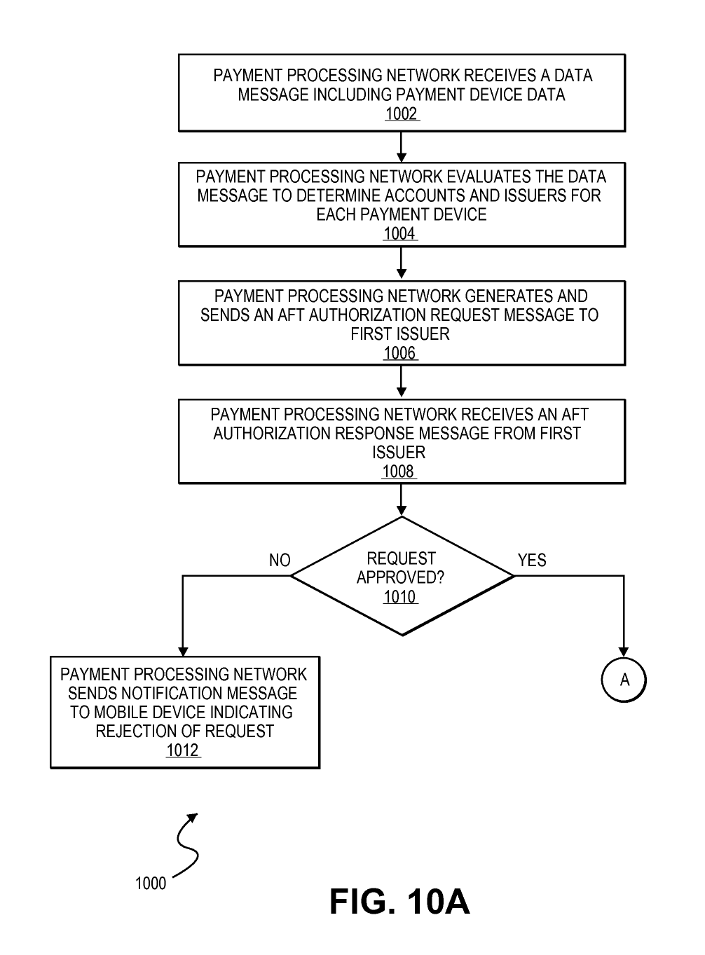

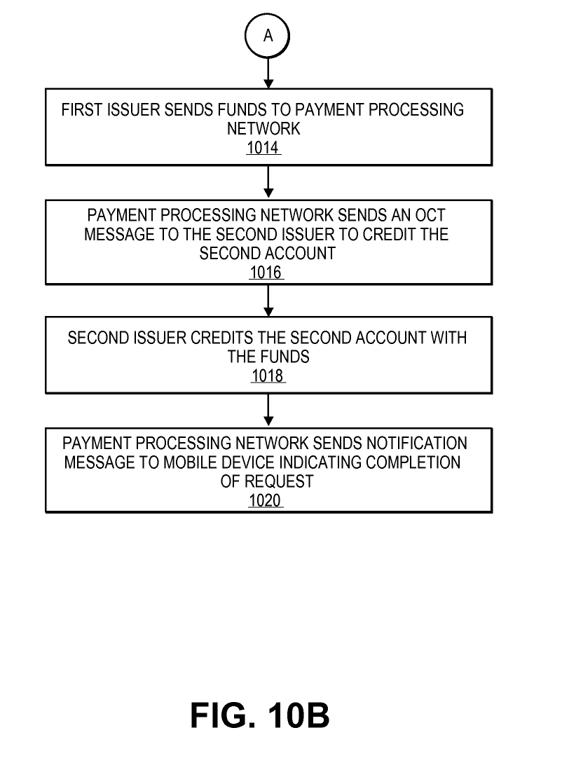

FIGS. 10A & 10B are flowcharts describing the process of transferring funds using a value transfer system according to an embodiment of the invention. The process will be described with reference to the embodiment of the invention depicted in FIGS. 9A-9C following the process described in FIG. 8.

In step 1002, a payment processing network 114 receives a data message including payment device data. As described previously, the data message may contain a transaction amount, and a first account identifier and second account identifier received from the reader device 110 associated with the mobile device 112.

In step 1004, the payment processing network 114 evaluates the data message to determine accounts and issuers for each payment device. The payment processing network 114 may evaluate the data message to determine a first issuer 104 associated with the first account identifier and a second issuer 108 associated with the second account identifier. In some situations, the first issuer 104 and the second issuer 108 may be the same if both the first payment device 102 and the second payment device 106 were issued from the same entity or institution. The issuers associated with each of the account identifiers may be identified based on a unique alphanumeric sequence of the account identifier. In other embodiments, the payment processing network 114 may have previously stored data regarding accounts and payment devices registered with the system and may parse a database to determine whether the account identifier has been previously stored at the payment processing network 114.

In step 1006, the payment processing network 114 generates and sends an AFT authorization request message to the first issuer computer 104. The AFT (Account Funding Transaction) authorization process is a transaction designed to supply funds to another account such as a prepaid card, debit card, credit card, ATM card or on-line account. The AFT authorization request message may include a debit request to debit the funding amount from the first account associated with the first payment device 102. In some embodiments, the AFT authorization request message may include only the account number or first account identifier associated with the first payment device 102, and may not carry any financial information about the recipient of the funds transfer (e.g., the second account identifier).

In step 1008, the payment processing network 114 receives an AFT authorization response message from first issuer computer 104. In some embodiments, assuming that funds are available (or that credit is available) from the first account associated with the first account identifier, the first issuer computer 104, the first issuer computer 104 may generate and send the AFT authorization response message to the payment processing network 114 indicating that the debit from the first account is approved. If funds are not available in the first account associated with the first account identifier, the first issuer computer 104 may generate and send the AFT authorization response message to the payment processing network 114 indicating that the debit from the first account is declined.

In step 1010, the payment processing network 114 determines whether the request to the first issuer computer 104 was approved. The request may not be approved when the first account associated with the first account identifier has insufficient funds for the funds transfer. When the funds transfer is declined by the first issuer computer 104, the process proceeds to step 1012. When the funds transfer is approved by the first issuer computer 104, the process proceeds to step 1014.

In step 1012, the payment processing network 114 sends a notification message to mobile device 112 indicating rejection of request. In some embodiments, when the funds transfer is declined by the first issuer computer 104, the payment processing network 114 may send a notification to the user. The notification may be sent via a data message from the payment processing network 114 to the application on the mobile device 112. In other embodiments, the notification may be in the form of an SMS text message, an electronic mail message, an automated telephone call, or any other suitable messaging means. In some embodiments, the notification is sent to another device of the user other than the mobile device 112.

In step 1014, first issuer computer 104 sends funds to the payment processing network 114. The first issuer computer 104 initiates the transfer of the funding amount to the second account from the first account associated with the first account identifier received from the first payment device 102. In some embodiments, the first issuer computer 104 initiates the process by debiting the funding amount from the first account (or by charging the first account an amount equal to the funding amount). Once the funding amount is charged against the first account, the first issuer computer 104 may transmit the funds back to the second issuer computer 108 via the payment processing network 114.

In step 1016, the payment processing network 114 sends an OCT message to the second issuer computer 108 to credit the second account. The Original Credit Transaction (OCT) request message may be a message sent as part of request to credit funds to an account. The OCT authorization request message may include a credit request to credit the funding amount to the second account associated with the second payment device 106. In some embodiments, the OCT request message may carry the amount of funds to the be credited to the second account and the account number or second account identifier associated with the second payment device 106, and may not carry any financial information about the first account identifier associated with the first payment device 102.

In step 1018, second issuer computer 108 credits the second account with the funds. The second issuer computer 108 evaluates the OCT request message and determines the second account from the second account identifier included in the OCT request message. The second issuer computer 108 may then credit the second account with the funding amount. In some embodiments, the second issuer computer 108 may generate and send an OCT response message indicating approval of the credit request.

In step 1020, the payment processing network 114 sends a notification message to mobile device 112 indicating completion of request. In some embodiments, when the funds transfer is completed, the payment processing network 114 may send a notification to the user. The notification may be sent via a data message from the payment processing network 114 to the application on the mobile device 112. In other embodiments, the notification may be in the form of an SMS text message, an electronic mail message, an automated telephone call, or any other suitable messaging means. In some embodiments, the notification is sent to another device of the user other than the mobile device 112.

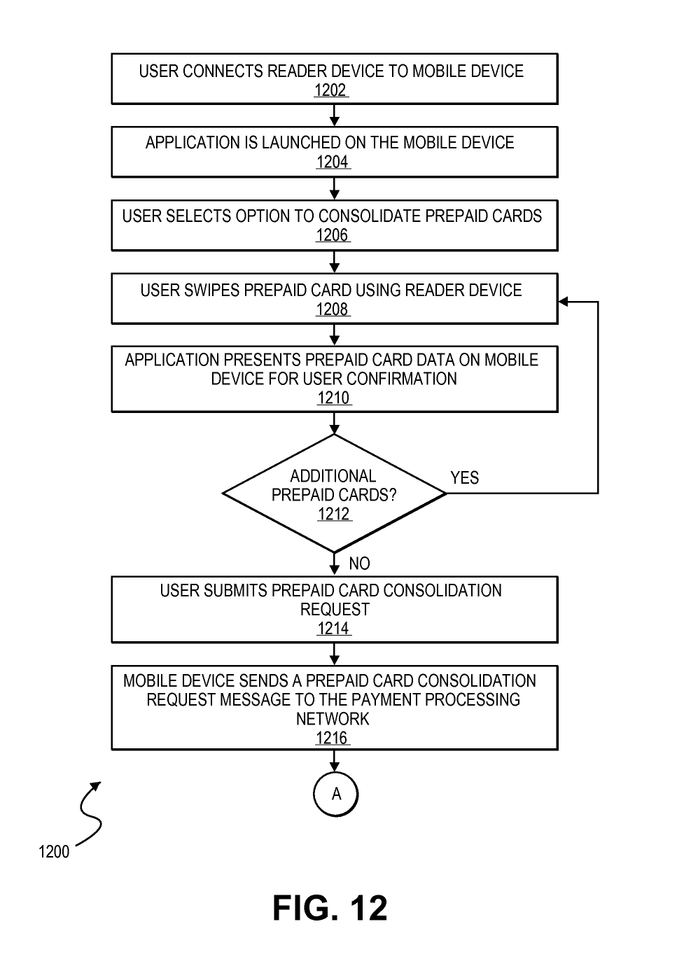

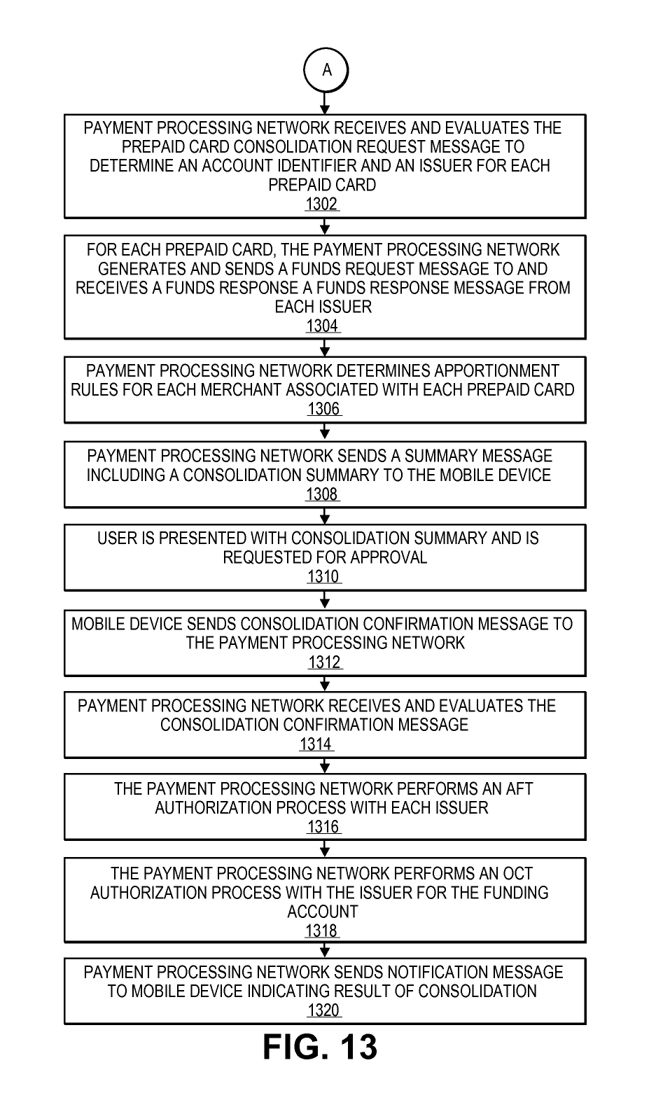

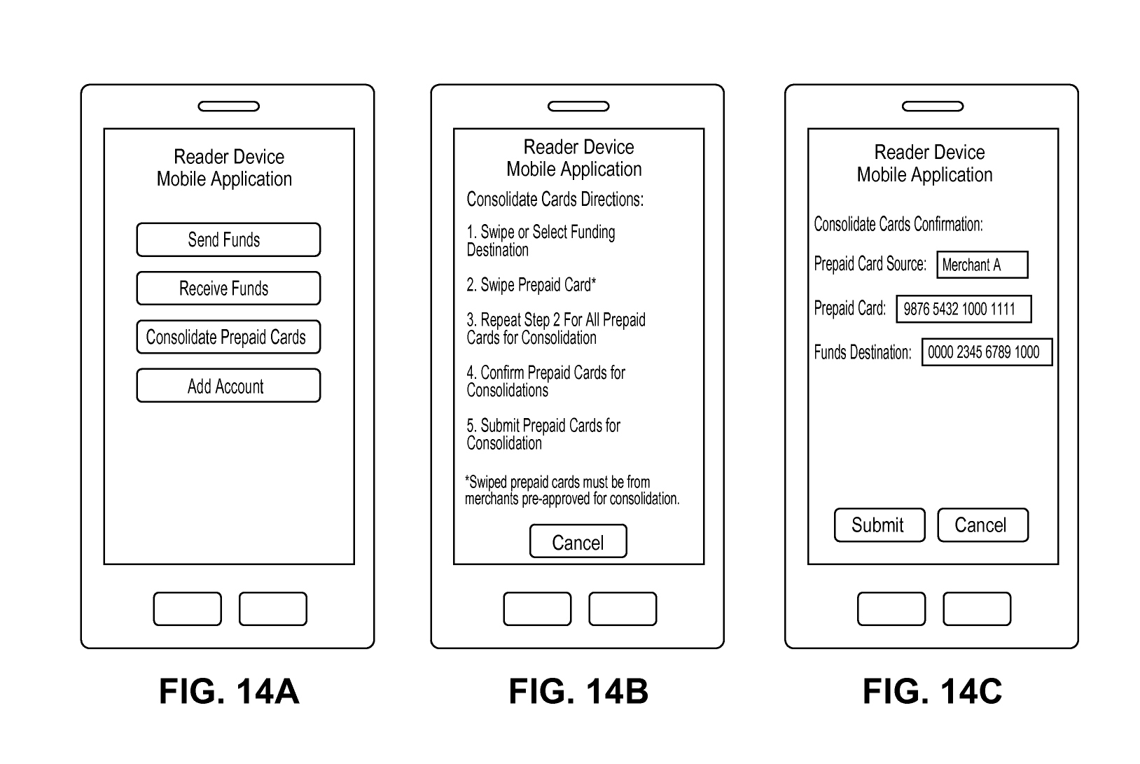

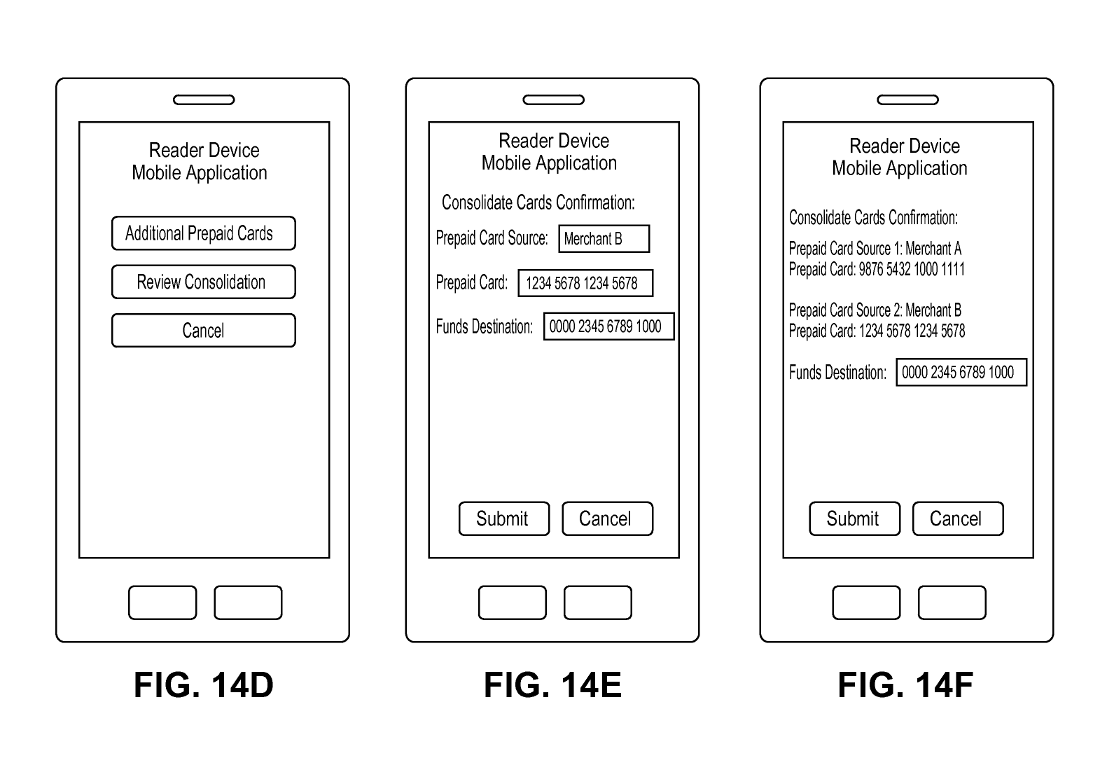

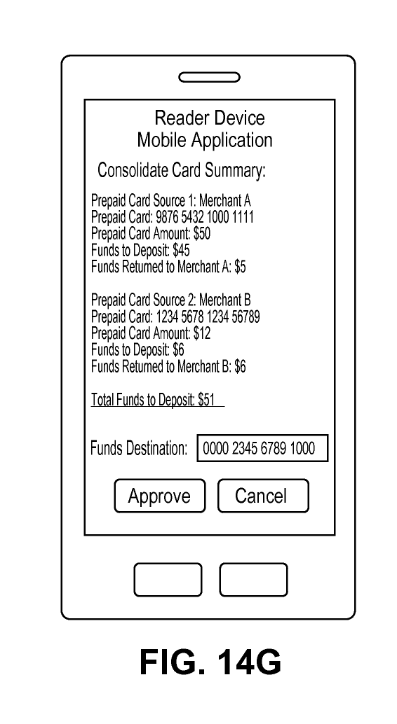

FIGS. 12-13 are flowcharts describing the process of consolidating prepaid cards using a value transfer system according to an embodiment of the invention. In some situations, a user may have a plurality of prepaid cards that either are of too little value or are for merchants that are undesirable for the user. For example, a user without children may not need a prepaid card for a merchant that sells children's clothes. Alternatively, a user may have several prepaid cards for a transit system that have value, but the values are sufficiently low that they cannot be used for transit. In such scenarios, the user may want consolidate the funds in one or more prepaid cards and have the values converted to a credit to one of their prepaid cards or to a financial account. Similarly, a user may have one or more prepaid cards from financial organizations (e.g., Visa, MasterCard, American Express) with low values that the user may want to consolidate. One issue that arises in these situations is that a merchant may be unwilling to give the user a full value of a prepaid card back in the form of a credit to the user's financial account. The process for performing a card consolidation, according to an embodiment of the claimed invention, will be described with reference to an embodiment of the invention depicted in FIGS. 14A-14G.

In step 1202, a user connects the reader device 110 to the mobile device 112. In some embodiments, the user may connect the reader device 110 to the mobile device 112 by inserting a connector portion 110(b) into a port (e.g., a 3.5 mm TRS or TRRS socket, USB port, or other physical interface) in the mobile device 112. A physical connection is depicted in FIG. 3B. In other embodiments, where the reader device 110 and the mobile device 112 are part of a single device, connecting the reader device 110 to the mobile device 112 may be accomplished by accessing an application on the mobile device 112, by engaging switch on the mobile device 112 from an “OFF” to “ON” position, or by any other comparable means of activating a device.

Connecting the reader device 110 to the mobile device 112 may also be a physical connection (e.g., inserting into a 3.5 mm TRS or TRRS socket, USB port, or other physical interface) or a wireless connection (e.g., by a Bluetooth™ connection or other suitable wireless connections that allow the transfer of data). In wireless embodiments, the reader device 110 may be connected to the mobile device 112 when the devices are moved within a predetermined range of each other.

In step 1204, an application is launched on the mobile device 112. In some embodiments, a value transfer application may be launched on a display of the mobile device 112. In some embodiments, the value transfer application may be automatically launched when the reader device 110 and the mobile device 112 are connected. In other embodiments, the application may be launched by the user selecting an application on the display of the mobile device 112.

In step 1206, the user selects an option to consolidate prepaid cards. When the application is launched on the mobile device 112, the user may be prompted to either provide login data (e.g., user name, password) or register the mobile device 112 with the reader device 110, as depicted in FIG. 7A. After providing correct login data, the user may then be presented with an options menu, as depicted in FIG. 14A. In some embodiments, the options menu presented by the value transfer application may include options to “Send Funds”, “Receive Funds”, “Consolidate Prepaid Cards”, or “Add Account”. Other embodiments may include additional or fewer options than those depicted in FIG. 11A.

The user may then select the “Consolidate Prepaid Cards” option from the options menus in FIG. 14A. The user may then be provided with instructions for conducting a “Consolidate Prepaid Cards” process, as depicted in FIG. 14B.

In step 1208, the user swipes a prepaid card using the reader device 110. In some embodiments, the reader device 110 receives a first account identifier from the first prepaid card 102 when the first prepaid card 102 is passed through (e.g., swiped or moved in proximity to) the reader device 110. As the first prepaid card 102 is passed through the reader device 110, the reader device 110 may read a magnetic stripe portion of the first prepaid card 102 containing financial data, including the first account identifier.

In some embodiments, after the first prepaid card 102 is swiped through the reader device 110, the reader device 110 may generate a data message including the first account identifier and send the data message to the mobile device 112. The data message may be sent from the reader device 110 to the mobile device 112 via the connector portion 110(b) connected with the mobile device 112. In other embodiments, where the mobile device 112 and the reader device 110 are a single device, the first account identifier may be accessed from a memory portion accessible by both the mobile device 112 and the reader device 110.

In step 1210, the application presents the prepaid card data on the mobile device 112 for a user confirmation. When the mobile device 112 receives the data message from the reader device 110, the mobile device 112 may present the data for the first prepaid card 102 on a display portion of the mobile device 112. An example screen is depicted in FIG. 14C. The example screen in FIG. 14C includes fields for “Prepaid Card Source” (e.g., the merchant associated with the prepaid card), “Prepaid Card” (e.g., the account identifier or prepaid card number), and the “Funds Destination.”

In step 1212, the user is prompted to indicate whether the user has additional prepaid cards for consolidation. FIG. 14D depicts an example of a screen that may be presented to the user via the application on the mobile device 112. The screen shows an option for “Additional Prepaid Cards”, an option for “Review Consolidation”, and an option to “Cancel” the process. The “Additional Prepaid Cards” option allows the user to provide additional prepaid cards for consolidation (e.g., via swiping additional prepaid cards). The “Review Consolidation” option allows the user to review a summary of the prepaid cards submitted for consolidation. Other embodiments may include additional or fewer options than those depicted in FIG. 14D. When the user has additional prepaid cards, the process returns to step 1208. The result of the process of swiping a second prepaid card 106 with the reader device 110 is shown in FIG. 14E. When the user does not have additional prepaid cards, the process proceeds to step 1214.

In step 1214, the user submits a prepaid card consolidation request. When the user indicates that there are not additional prepaid cards for consolidation, the user can select the “Review Consolidation” option shown on FIG. 14D. In some embodiments, the user may then be prompted to provide a funding account (e.g., account data for an account that the funds will be deposited into). In other embodiments, the user may be prompted to provide the funds destination account prior to providing the prepaid cards.

As depicted in FIG. 14F, the user may then be presented with a summary of the prepaid cards submitted for consolidation. The summary page in FIG. 14F includes the first prepaid card 102 from FIG. 14C and the second prepaid card 106 from FIG. 14E. The summary may include the merchant and account identifier for each prepaid card and the funding account. In some embodiments, the reader device 110 and the mobile device 112 do not know the value of the prepaid cards (102 and 106). In other embodiments, the reader device 110 may be configured to read a value of the prepaid cards from the magnetic stripe portion of the prepaid cards. The user can then “Submit” the consolidation request or “Cancel” the request.

In step 1216, the mobile device 112 sends a prepaid card consolidation request message to a payment processing network 114. When the user submits the prepaid card consolidation request, the application on the mobile device 112 may generate a data message containing the received first account identifier, second account identifier, and funding account. The data message may then be sent to the payment processing network 114. The data message may be sent by any appropriate communications means, including as data packets transmitted across a wireless communications network (e.g., the Internet), or via SMS text messaging. The data message may be sent over a transport layer security (TLS) or secure socket layer (SSL) connection. In some embodiments, the data message may be encrypted prior to being sent to the payment processing network 114 to ensure that the secure data cannot be easily intercepted and used without knowledge of a key used to encrypt and decrypt the data message.

FIG. 13 describes a process of consolidating prepaid cards performed by a payment processing network, following the process performed by the mobile device described in FIG. 12. In step 1302, the payment processing network 114 receives and evaluates the prepaid card consolidation request message sent in step 1216 to determine an account identifier and an issuer associated with each prepaid card. As described previously, a funding account, a first account identifier, and a second account identifier received from the reader device 110 associated with the mobile device 112. The payment processing network 114 may evaluate the data message to determine a first issuer 104 associated with the first account identifier and a second issuer 108 associated with the second account identifier. In some situations, the first issuer 104 and the second issuer 108 may be the same if both the first payment device 102 and the second payment device 106 were issued from the same entity or institution. The issuers associated with each of the account identifiers may be identified based on a unique alphanumeric sequence of the account identifier. In other embodiments, the payment processing network 114 may have previously stored data regarding accounts and payment devices registered with the system and may parse a database to determine whether the account identifier has been previously stored at the payment processing network 114.

In step 1304, for each prepaid card, the payment processing network 114 generates and sends a funds request message to the appropriate issuer and receives a funds response message. In some embodiments, the payment processing network 114 generates and sends a funds request message to each issuer associated with each prepaid card in order to determine the balance of each of the submitted prepaid cards. For example, the payment processing network 114 may send a first funds request message to a first issuer computer 104 associated with the first account identifier, and a second funds request message to a second issuer computer 108 associated with the second account identifier. Each issuer computer (104 and 108) may then evaluate the received funds request message, and identify the account and a corresponding funds balance associated with each account. Each issuer computer (104 and 108) may then generate and send funds responses messages back to the payment processing network 114 including the balance of the accounts. The messages may be sent through any appropriate messaging means, as previously described.

In step 1306, the payment processing network 114 determines apportionment rules for each merchant associated with each prepaid card. For example, a first merchant (“Merchant A”) in the example of FIGS. 14A-14G may have an apportionment rule where the user gets 90% of the value of the prepaid card and the merchant retains 10%. A second merchant (“Merchant B”) may have an apportionment rule where the user gets 50% of the value of the prepaid card and the merchant retains 50%. Merchants may define their own apportionment rules that can be stored at the payment processing network 114 or at the appropriate issuer computer and sent to the payment processing network as part of the funds response message.

In step 1308, the payment processing network 114 sends a summary message including a consolidation summary to the mobile device 112. When the payment processing network 114 has determined the apportionment rules for each of the prepaid cards, the payment processing network 114 may generate a consolidation summary with the transaction details for each prepaid card submitted by the user. The summary message may be sent via a data message from the payment processing network 114 to the application on the mobile device 112. In other embodiments, the summary message may be in the form of an SMS text message, an electronic mail message, an automated telephone call, or any other suitable messaging means. In some embodiments, the summary message is sent to another device of the user other than the mobile device 112.

In step 1310, the user is presented with the consolidating summary and approval of the user is requested. FIG. 14G is a depiction of an example consolidation summary screen as presented on the display of the mobile device 112. The consolidation summary screen includes the first account identifier read from the first prepaid card 102, and the second account identifier read from the second prepaid card 106, as well as a summary of the apportionment for the first prepaid card 102 and the second prepaid card 106. As shown in FIG. 14G, based on the apportionment rules for each prepaid card, the user may consolidate the cards and receive funds to the designated funding destination for $51.

In step 1312, the mobile device 112 sends a consolidation confirmation message to the payment processing network 114. The mobile device may send a consolidation confirmation message to the payment processing network 114 indicating whether the user has selected to “Submit” the consolidation for processing or cancel the consolidation.

In step 1314, the payment processing network 114 receives and evaluates the consolidation confirmation message from the mobile device 112. In some embodiments, as the payment processing network 114 previously determined the appropriate issuer computer for each prepaid card, the payment processing network 114 might only need to determine whether the user has selected to proceed with the prepaid card consolidation process. In some embodiments, the payment processing network 114 may access a stored summary of the consolidation including the account identifiers and appropriate issuers for the consolidation. For example, the payment processing network may save a message similar to the summary presented to the user in FIG. 14G, including the first account identifier, the second account identifier, the funding account, and the transaction totals for each prepaid card.

In step 1316, the payment processing network 114 performs an AFT authorization process with each issuer. The AFT authorization request message may include a debit request to debit an apportioned amount from a first account associated with the first prepaid card 102. In some embodiments, the AFT authorization request message may include only the account number or first account identifier associated with the first prepaid card 102, and may not carry any financial information about the recipient of the funds transfer (e.g., the funding account). In other embodiments, the AFT authorization request message may include a debit request to debit an apportioned amount from a merchant account or an issuer account.

In response to the AFT authorization request message, the payment processing network 114 may receive an AFT authorization response message from the first issuer computer 104. In some embodiments, assuming that funds are available (or that credit is available) from the first account associated with the first account identifier (or from the merchant account or the issuer account), the first issuer computer 104 may generate and send the AFT authorization response message to the payment processing network 114 indicating that the debit from the first account is approved or declined.

In step 1318, the payment processing network 114 performs an OCT authorization process with each issuer. An OCT authorization request message may be sent from the payment processing network 114 to the issuer computer associated with the funding account. The OCT authorization request message may include a credit request to credit the funding amount to the funding account that the user has provided for depositing the consolidated prepaid card value to. In some embodiments, the funding account may be associated with a different prepaid card, a credit card, a debit card, a checking account, a savings account, or the like. In some embodiments, the OCT request message may carry the amount of funds to the be credited to the funding account and an account number or an account identifier associated with the funding account, and may not carry any financial information about the account identifiers associated with the prepaid cards being consolidated.

The issuer computer may then credit the funding account with the funds. The funding account evaluates the OCT request message and determines the funding account from the account identifier included in the OCT request message. The issuer computer may then credit the funding account with the funding amount. In some embodiments, the issuer computer may generate and send an OCT response message indicating approval of the credit request.

In step 1320, the payment processing network 114 sends a notification message to the mobile device 112 indicating result of consolidation. In some embodiments, when the card consolidation process is completed, the payment processing network 114 may send a notification to the user. The notification may be sent via a data message from the payment processing network 114 to the application on the mobile device 112. In other embodiments, the notification may be in the form of an SMS text message, an electronic mail message, an automated telephone call, or any other suitable messaging means. In some embodiments, the notification is sent to another device of the user other than the mobile device 112.

### III. Technical Benefits

One benefit of embodiments of the invention is the ability to conduct a funds transfer from a first payment device (e.g., credit card, debit card, prepaid card) to a second payment device using a reader device associated with a mobile device. The ability to use a reader device that can be embedded within or connected to a mobile device allows for more efficient and less time-consuming peer-to-peer money transfers between individuals.

In addition, the ability to uniquely register the reader device to a specific mobile device ensures greater security from fraud and minimizes the risk that the financial data associated with and/or stored in a memory portion of the reader device may be accessed or intercepted.

### IV. Additional Embodiments

In additional embodiments, the transfer of funds between the first issuer computer 104 and the second issuer computer 108 may be conducted using a clearing and settlement process. In such embodiments, the payment processing network 114 may initiate a clearing and settlement with the first issuer computer 104 for funds. In some embodiments, when the funds transfer is approved by the first issuer computer 104, the payment processing network 114 may initiate a clearing and settlement process with the first issuer computer 104 for the funds for the funds transfer. In some embodiments of the invention, the funds transfer is conducted in a clearing and settlement process where monetary funds are electronically debited from a first account at the first issuer computer 104 and sent through a payment processing network 114 to a second account at the second issuer computer 108.

A clearing and settlement process may include a process of reconciling a transaction. A clearing process is a process of exchanging financial details between first issuer computer 104 and a second issuer computer 108 to facilitate posting to an account and reconciliation of the user's settlement position. Settlement involves the delivery of securities from one user to another. In some embodiments, clearing and settlement can occur simultaneously. In some embodiments, the settlement process can be conducted using standard financial transaction messaging formats.

For example, standard BASE II settlement records or Single Message System (SMS) messages may be used. BASE II is a data processing network operated by VISA for the clearing and settlement of payment device transactions between payment device-issuing issuer.

The payment processing network 114 may generate a settlement file including the first account identifier and the funding amount. The payment processing network 114 may then route the settlement file to the first issuer computer 104. The payment processing network 114 can send the settlement file to the first issuer computer 104 by any appropriate messaging means. The first issuer computer 104 receives the settlement file comprising transaction details.

The payment processing network 114 may then perform a clearing and settlement with the second issuer computer 108 for the funding amount. The payment processing network 114 may generate a settlement file including the second account identifier and the funding amount. The payment processing network 114 may then route the settlement file to the second issuer computer 108. The payment processing network 114 can send the settlement file to the second issuer computer 108 by any appropriate messaging means. The second issuer computer 108 receives the settlement file comprising transaction details and funds the second account.

In some embodiments, the process for registering the reader device 110 may be accomplished by the user connecting or associating the reader device 110 with the mobile device 112. For example, when the reader device 110 and the mobile device 112 are first connected, the application (on either the reader device 110 or the mobile device 112) may be configured to automatically register or pair the two devices. In some embodiments, this may result in the reader device 110 and the mobile device 112 being uniquely paired.

In some embodiments, a clearinghouse (e.g., Automated Clearing House (ACH)) may be used in place of the AFT and OCT messages for transferring the funds from a first account at a first issuer to a second account at a second issuer. Transactions processed through a clearinghouse may be used to send or receive between individuals and corporations. For example, a clearinghouse may be used for a point-of-purchase (POP) transaction where a physical check is presented in order to send funds, or for a point-of-sale (POS) transaction where a payment device (e.g., a credit or debit card) is used. For a POP transaction, the user may enter the routing number, account number and check serial number using the application on the mobile device 112. For a POS transaction, the user may swipe the payment device through the reader device 110. The data may then be sent to a payment processing network 114 for sending to the appropriate issuers.

The example screens depicted in FIGS. 5A-5B, 7A-7C, 9A-9C, 11A-11C, and 14A-14G are one embodiment of an application that may be used in conjunction with the system 100 in FIG. 1 to conduct value transfers using payment devices. Some embodiments may include few or additional features and requirements. Other embodiments may provide different user interfaces.

### V. Exemplary Apparatuses

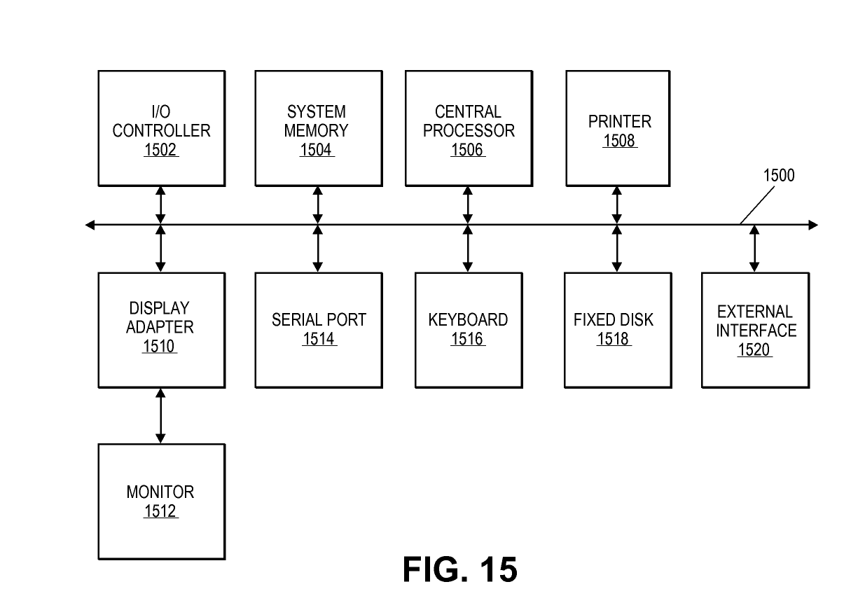

The various participants and elements may operate one or more computer apparatuses (e.g., a server computer) to facilitate the functions described herein. Any of the elements in the figures may use any suitable number of subsystems to facilitate the functions described herein. Examples of such subsystems or components are shown in FIG. 15. The subsystems shown in FIG. 15 are interconnected via a system bus 1500. Additional subsystems such as a printer 1508, keyboard 1516, fixed disk 1518 (or other memory comprising computer readable media), monitor 1512, which is coupled to display adapter 1510, and others are shown. Peripherals and input/output (I/O) devices, which couple to I/O controller 1502, can be connected to the computer system by any number of means known in the art, such as serial port 1514. For example, serial port 1514 or external interface 1520 can be used to connect the computer apparatus to a wide area network such as the Internet, a mouse input device, or a scanner. The interconnection via system bus 1500 allows the central processor 1506 to communicate with each subsystem and to control the execution of instructions from system memory 1504 or the fixed disk 1518, as well as the exchange of information between subsystems. The system memory 1504 and/or the fixed disk 1518 may embody a computer readable medium.

Further, while the present invention has been described using a particular combination of hardware and software in the form of control logic and programming code and instructions, it should be recognized that other combinations of hardware and software are also within the scope of the present invention. The present invention may be implemented only in hardware, or only in software, or using combinations thereof.

The software components or functions described in this application may be implemented as software code to be executed by one or more processors using any suitable computer language such as, for example, Java, C++ or Perl using, for example, conventional or object-oriented techniques. The software code may be stored as a series of instructions, or commands on a computer-readable medium, such as a random access memory (RAM), a read-only memory (ROM), a magnetic medium such as a hard-drive or a floppy disk, or an optical medium such as a CD-ROM. Any such computer-readable medium may also reside on or within a single computational apparatus, and may be present on or within different computational apparatuses within a system or network.

The present invention can be implemented in the form of control logic in software or hardware or a combination of both. The control logic may be stored in an information storage medium as a plurality of instructions adapted to direct an information processing device to perform a set of steps disclosed in embodiments of the present invention. Based on the disclosure and teachings provided herein, a person of ordinary skill in the art will appreciate other ways and/or methods to implement the present invention.

It is understood that the examples and embodiments described herein are for illustrative purposes only and that various modifications or changes in light thereof will be suggested to persons skilled in the art and are to be included within the spirit and purview of this application and scope of the appended claims. All publications, patents, and patent applications cited in this patent are hereby incorporated by reference for all purposes.

One or more features from any embodiment may be combined with one or more features of any other embodiment without departing from the scope of the disclosure.

In some embodiments, any of the entities described herein may be embodied by a computer that performs any or all of the functions and steps disclosed.

Any recitation of “a”, “an” or “the” is intended to mean “one or more” unless specifically indicated to the contrary.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

What is claimed is:

1. A method comprising:
receiving, by a reader device, a first account identifier from a first payment device when the first payment device is passed through the reader device;
receiving, by the reader device, a second account identifier from a second payment device when the second payment device is passed through the reader device;
generating a data message including the first account identifier and the second account identifier; and
sending, to a mobile device associated with the reader device, the data message for transferring funds between a first account associated with the first account identifier and a second account associated with the second account identifier.

2. The method of claim 1 wherein the first account identifier and the second account identifier are stored in a memory portion in the reader device.

3. The method of claim 1 wherein the first account identifier is read from a first magnetic stripe portion of the first payment device when the first payment device is in proximity to the reader device, and wherein the second account identifier is read from a second magnetic stripe portion of the second payment device when the second payment device is in proximity to the reader device

4. The method of claim 1 wherein reader device is connected to the mobile device by a wireless connection.

5. The method of claim 1 wherein the data message is sent to the mobile device as a signal transmitted over a connection between the mobile device and the reader device.

6. The method of claim 1 wherein the reader device is connected to the mobile device using a connector portion.

7. A method comprising:
receiving, from a mobile device, a message including a first account identifier and a second account identifier, the first account identifier and the second account identifier previously received by the mobile device via a reader device associated with the mobile device, and a transaction amount;
evaluating, by a computer, the message to determine a first issuer associated with the first account identifier and a second issuer associated with the second account identifier; and
initiating a transfer of funds for the transaction amount from a first account at the first issuer to a second account at the second issuer.

8. The method of claim 7 wherein initiating the transfer of funds for the transaction amount from the first account at the first issuer to the second account at the second issuer further comprises:
sending an AFT request message to the first issuer including a debit request to debit the transaction amount from the first account;
receiving an AFT response message indicating approval of the debit request;
sending an OCT request message to the second issuer including a credit request to credit the transaction amount to the second account; and
receiving an OCT response message indicating approval of the credit request.

9. The method of claim 7 wherein initiating the transfer of funds for the transaction amount from the first account at the first issuer to the second account at the second issuer further comprises:
sending a settlement message for the transaction amount to the first issuer;
receiving the funds for the transaction amount from the first issuer; and
sending the funds for the transaction amount to the second issuer.

10. The method of claim 7 wherein initiating the transfer of funds for the transaction amount from the first account at the first issuer to the second account at the second issuer further comprises:
determining apportionment rules for a merchant associated with the first account, wherein the first account is a prepaid account, and wherein the apportionment rules for the merchant associated with the first account include a rule for apportioning the transaction amount associated with the prepaid account between the merchant and the user.

11. The method of claim 10 further comprising:
sending a confirmation request message to the mobile device including the transaction amount and an apportionment of the transaction amount based on the apportionment rules; and
receiving a confirmation response message from the mobile device.

12. The method of claim 10 wherein the message further includes a third account identifier previously received by the mobile device via the portable reader device, wherein the third account identifier is for a second prepaid account.

13. The method of claim 7 further comprising:
sending a notification indicating completion of the transfer of funds.

14. A server computer comprising a processor, and a computer readable medium coupled to the processor, the computer readable medium comprising code for implementing a method comprising:
receiving, from a mobile device, a message including a first account identifier and a second account identifier, the first account identifier and the second account identifier previously received by the mobile device via a reader device associated with the mobile device, and a transaction amount;
evaluating, by a computer, the message to determine a first issuer associated with the first account identifier and a second issuer associated with the second account identifier; and
initiating a transfer of funds for the transaction amount from a first account at the first issuer to a second account at the second issuer.

15. The server computer of claim 14 wherein initiating the transfer of funds for the transaction amount from the first account at the first issuer to the second account at the second issuer further comprises:
sending an AFT request message to the first issuer including a debit request to debit the transaction amount from the first account;
receiving an AFT response message indicating approval of the debit request;
sending an OCT request message to the second issuer including a credit request to credit the transaction amount to the second account; and
receiving an OCT response message indicating approval of the credit request.

16. The server computer of claim 14 wherein initiating the transfer of funds for the transaction amount from the first account at the first issuer to the second account at the second issuer further comprises:
sending a settlement message for the transaction amount to the first issuer;
receiving the funds for the transaction amount from the first issuer; and
sending the funds for the transaction amount to the second issuer.

17. The server computer of claim 14 wherein initiating the transfer of funds for the transaction amount from the first account at the first issuer to the second account at the second issuer further comprises:
determining apportionment rules for a merchant associated with the first account, wherein the first account is a prepaid account, and wherein the apportionment rules for the merchant associated with the first account include a rule for apportioning the transaction amount associated with the prepaid account between the merchant and the user.

18. The server computer of claim 17 further comprising:
sending a confirmation request message to the mobile device including the transaction amount and an apportionment of the transaction amount based on the apportionment rules; and
receiving a confirmation response message from the mobile device.

19. The server computer of claim 17 wherein the message further includes a third account identifier previously received by the mobile device via the portable reader device, wherein the third account identifier is for a second prepaid account.

20. The server computer of claim 14 further comprising:
sending a notification indicating completion of the transfer of funds.
